(19) United States
(12) Patent Application Publication
(10) Pub. No.: US 2025/0046063 A1
(43) Pub. Date: Feb. 6, 2025

(54) CELL CLASSIFICATION USING CENTER EMPHASIS OF A FEATURE MAP

(71) Applicants: Genentech, Inc., South San Francisco, CA (US); Ventana Medical Systems, Inc., Tucson, AZ (US); Hoffmann-La Roche Inc., Nutley, NJ (US); Roche Molecular Systems, Inc., Pleasanton, CA (US)

(72) Inventors: Karol Badowski, Warsaw (PL); Hartmut Koeppen, San Mateo, CA (US); Konstanty Korski, Basel-City (CH); Yao Nie, Sunnyvale, CA (US)

(73) Assignees: Genentech, Inc., South San Francisco, CA (US); Ventana Medical Systems, Inc., Tucson, AZ (US); Hoffmann-La Roche Inc., Nutley, NJ (US); Roche Molecular Systems, Inc., Pleasanton, CA (US)

(21) Appl. No.: 18/921,918

(22) Filed: Oct. 21, 2024

Related U.S. Application Data
(63) Continuation of application No. PCT/US2023/017131, filed on Mar. 31, 2023.
(60) Provisional application No. 63/333,924, filed on Apr. 22, 2022.

(51) Int. Cl. G06V 10/77; G06V 10/80; G06V 10/82; G06V 20/69

(52) U.S. Cl. CPC G06V 10/7715; G06V 10/806; G06V 10/82; G06V 20/695; G06V 20/698

(57) ABSTRACT

Techniques described herein include, for example, generating a feature map for an input image, generating a plurality of concentric crops of the feature map, and generating an output vector that represents a characteristic of a structure depicted in a center region of the input image using the plurality of concentric crops. Generating the output vector may include, for example, aggregating sets of output features generated from the plurality of concentric crops, and several methods of aggregating are described. Applications to classification of a structure depicted in the center region of the input image are also described.

### CROSS REFERENCE TO RELATED APPLICATIONS

The present application is a continuation of International Application No. PCT/US2023/017131, filed on Mar. 31, 2023, which claims priority to U.S. Provisional Application No. 63/333,924, filed on Apr. 22, 2022, which are incorporated herein by reference in their entireties for all purposes.

### BACKGROUND

Digital pathology may involve the interpretation of digitized images in order to correctly diagnose diseases of subjects and guide therapeutic decision making. In digital pathology solutions, image-analysis workflows can be established to automatically detect or classify biological objects of interest (e.g., tumor cells that are positive or negative for a particular biomarker or other indicator, etc.). An exemplary digital pathology solution workflow includes obtaining a slide of a tissue sample, scanning preselected areas or the entirety of the tissue slide with a digital image scanner (e.g., a whole slide image (WSI) scanner) to obtain a digital image, performing image analysis on the digital image using one or more image analysis algorithms (e.g., to detect objects of interest). Such a workflow may also include quantifying objects of interest based on the image analysis (e.g., counting or identifying object-specific or cumulative areas of the objects) and may further include quantitative or semi-quantitative scoring of the sample (e.g., as positive, negative, medium, weak, etc.) based on a result of the quantifying.

### SUMMARY

In various embodiments, a computer-implemented method for classifying an input image is provided that includes generating a feature map for the input image using a trained neural network that includes at least one convolutional layer; generating a plurality of concentric crops of the feature map; generating an output vector that represents a characteristic of a structure depicted in a center region of the input image using information from each of the plurality of concentric crops; and determining a classification result by processing the output vector.

In some embodiments, generating the output vector using the plurality of concentric crops includes, for each of the plurality of concentric crops, generating a corresponding one of a plurality of feature vectors using at least one pooling operation; and generating the output vector using the plurality of feature vectors. In such a method, the plurality of feature vectors may be ordered by radial size of the corresponding concentric crop, and generating the output vector may include convolving a trained filter separately over adjacent pairs of the ordered plurality of feature vectors.

In some embodiments, generating the output vector using the plurality of concentric crops includes, for each of the plurality of concentric crops, generating a corresponding one of a plurality of feature vectors using at least one pooling operation; and generating the output vector using the plurality of feature vectors. In such a method, the plurality of feature vectors may be ordered by radial size of the corresponding concentric crop, and generating the output vector may include convolving a trained filter over a first adjacent pair of the ordered plurality of feature vectors to produce a first combined feature vector; and convolving the trained filter over a second adjacent pair of the ordered plurality of feature vectors to produce a second combined feature vector. In such a method, generating the output vector using the plurality of feature vectors may comprise generating the output vector using the first combined feature vector and the second combined feature vector.

In various embodiments, a computer-implemented method for classifying an input image is provided that includes generating a feature map for the input image; generating a plurality of feature vectors using information from the feature map; generating a second plurality of feature vectors using a trained shared model that is applied separately to each of the plurality of feature vectors; generating an output vector that represents a characteristic of a structure depicted in the input image using information from each of the second plurality of feature vectors; and determining a classification result by processing the output vector.

In various embodiments, a computer-implemented method for training a classification model that includes a first neural network and a second neural network is provided that includes generating a plurality of feature maps using the first neural network and information from images of a first dataset; and training the second neural network using the plurality of feature maps. In this method, each image of the first dataset depicts at least one biological cell, and the first neural network is pre-trained on a plurality of images of a second dataset that includes images which do not depict biological cells.

In various embodiments, a computer-implemented method for classifying an input image is provided that includes generating a feature map for the input image using a first trained neural network of a classification model; generating an output vector that represents a characteristic of a structure depicted in a center portion of the input image using a second trained network of the classification model and information from the feature map; and determining a classification result by processing the output vector. In this method, the input image depicts at least one biological cell, the first trained neural network is pre-trained on a first plurality of images that includes images which do not depict biological cells, and the second trained neural network is trained by providing the classification model with a second plurality of images that depict biological cells.

In some embodiments, a system is provided that includes one or more data processors and a non-transitory computer readable storage medium containing instructions which, when executed on the one or more data processors, cause the one or more data processors to perform part or all of one or more methods disclosed herein.

In some embodiments, a computer-program product is provided that is tangibly embodied in a non-transitory machine-readable storage medium and that includes instructions configured to cause one or more data processors to perform part or all of one or more methods disclosed herein.

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

### BRIEF DESCRIPTIONS OF THE DRAWINGS

The patent or application file contains at least one drawing executed in color. Copies of this patent or patent application publication with color drawing(s) will be provided by the Office upon request and payment of the necessary fee.

Aspects and features of the various embodiments will be more apparent by describing examples with reference to the accompanying drawings, in which:

FIG. 1A shows an example of an image processing pipeline 100 according to some embodiments.

FIG. 1B shows an example of an input image in which a candidate (a structure that is predicted to be of a particular class) is centered.

FIG. 2A shows another example of an input image in which a candidate (indicated by the red circle) is centered.

FIG. 2B shows an example of an input image in which the candidate (indicated by the red circle) is not in the center of the image.

FIG. 2C shows an example of an input image in which a candidate (indicated by the red circle) is surrounded by several structures of another class.

FIG. 3 shows six different examples of an importance mask.

FIG. 4A illustrates a flowchart for an exemplary process to classify an input image according to some embodiments.

FIG. 4B illustrates a block diagram of an exemplary architecture component for classifying an input image according to some embodiments.

FIG. 5A shows an example of actions in which a feature map for an input image is generated according to some embodiments.

FIG. 5B shows an example of actions in which a plurality of concentric crops of a feature map is generated according to some embodiments.

FIG. 6 shows another example of actions in which a feature map for an input image and a plurality of concentric crops of the feature map are generated according to some embodiments.

FIG. 7 shows an example of actions in which a corresponding downsampling operation is performed on each of a plurality of concentric crops to produce a corresponding downsampled feature map, a combining operation is performed on downsampled feature maps to produce an output vector, and the output vector is processed to produce a classification result according to some embodiments.

FIG. 8 shows an example of four classes of structures.

FIG. 9 shows an example of a feature map, a corresponding plurality of concentric crops, and a corresponding plurality of feature vectors according to some embodiments.

FIG. 10 shows the example of FIG. 9 further including an output vector according to some embodiments.

FIG. 11A illustrates a flowchart for another exemplary process to classify an input image according to some embodiments.

FIG. 11B illustrates a block diagram of another exemplary architecture component for classifying an input image according to some embodiments.

FIG. 12 shows the example of FIG. 9 further including a shared model and an output vector according to some embodiments.

FIG. 13 shows the example of FIG. 9 further including convolution over radii and an output vector according to some embodiments.

FIG. 14A shows an example of actions in which an output vector is generated using a plurality of concentric crops of a feature map according to some embodiments.

FIG. 14B shows a block diagram of an implementation of an output vector generating module according to some embodiments.

FIG. 15A shows a block diagram of an implementation of a combining module according to some embodiments.

FIG. 15B shows a block diagram of an implementation of an additional feature vector generating module according to some embodiments.

FIG. 16A shows a block diagram of an implementation of an architecture component according to some embodiments.

FIG. 16B shows a block diagram of an implementation of a feature vector generating module according to some embodiments.

FIG. 17A illustrates a flowchart for an exemplary process to train a classification model that includes a first neural network and a second neural network according to some embodiments.

FIG. 17B illustrates a flowchart for an exemplary process to classify an input image according to some embodiments.

FIG. 18A illustrates a flowchart for an exemplary process to classify an input image according to some embodiments.

FIG. 18B illustrates a flowchart for an exemplary process to classify an input image according to some embodiments.

FIG. 19A shows a schematic diagram of an encoder-decoder network according to some embodiments.

FIG. 19B shows an example of actions in which a feature map for an input image is generated using a trained encoder according to some embodiments.

FIG. 20 shows examples of input images and corresponding reconstructed images as produced by an encoder-decoder network (also called an ‘autoencoder’ network) according to some embodiments at different epochs of training.

FIG. 21 shows examples of input images and corresponding reconstructed images as produced by various encoder-decoder networks according to some embodiments.

FIG. 22A shows an example of actions in which feature maps for an input image are generated using a trained encoder and a trained neural network according to some embodiments.

FIG. 22B shows an example of actions in which a feature map for an input image is generated using a plurality of feature maps and a combining operation according to some embodiments.

FIG. 23 shows an example of actions in which an output vector is generated using a plurality of concentric crops of a feature map according to some embodiments.

FIG. 24 shows an example of actions in which an output vector is generated using a feature map according to some embodiments.

FIG. 25A shows an example of actions in which feature maps for an input image are generated using a trained neural network according to some embodiments.

FIG. 25B shows an example of actions in which a feature map for an input image is generated using a plurality of feature maps and a combining operation according to some embodiments.

FIG. 26 shows an example of actions in which an output vector is generated using a plurality of concentric crops of a feature map according to some embodiments.

FIG. 27 shows an example of actions in which a feature map for an input image is generated according to some embodiments.

FIG. 28 shows an example of actions in which an output vector is generated using a plurality of concentric crops of a feature map according to some embodiments.

FIG. 29 shows an example of actions in which a feature map for an input image is generated according to some embodiments.

FIG. 30 shows an example of actions in which an output vector is generated using a plurality of concentric crops of a feature map according to some embodiments.

FIG. 31 shows an example of a computing system according to some embodiments that may be configured to perform a method as described herein.

FIG. 32 shows an example of a precision-recall curve for a model as described herein according to some embodiments.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

Techniques described herein include, for example, generating a feature map for an input image, generating a plurality of concentric crops of the feature map, and generating an output vector that represents a characteristic of a structure depicted in a center region of the input image using the plurality of concentric crops. Generating the output vector may include, for example, aggregating sets of output features generated from the plurality of concentric crops, and several methods of aggregating are described. For example, aggregating sets of output features generated from the plurality of concentric crops may be performed using “radius convolution,” which is defined as convolution over feature maps or vectors that are derived from concentric crops of a feature map at multiple radii and/or convolution, for each of a plurality of concentric crops of a feature map at different radii, along a corresponding feature map or vector that is derived from the crop. Applications to classification of a structure depicted in the center region of the input image are also described.

One or more such techniques may be applied, for example, to a convolutional neural network competent for image classification applications. Technical advantages of such techniques may include, for example, improved image processing (e.g., higher true positives/negatives/detection, lower false positives/negatives), improved prognosis evaluation, improved diagnosis facilitation, and/or improved treatment recommendation. Exemplary use cases presented herein include mitosis detection and classification from images of stained tissue samples (e.g., hematoxylin-and-eosin (H&E)-stained tissue samples).

### 1. BACKGROUND

A tissue sample (e.g., a sample of a tumor) may be fixed and/or embedded using a fixation agent (e.g., a liquid fixing agent, such as a formaldehyde solution) and/or an embedding substance (e.g., a histological wax, such as a paraffin wax and/or one or more resins, such as styrene or polyethylene). The fixed tissue sample may also be dehydrated (e.g., via exposure to an ethanol solution and/or a clearing intermediate agent) prior to embedding. The embedding substance can infiltrate the tissue sample when it is in liquid state (e.g., when heated). The fixed, dehydrated, and/or embedded tissue sample may be sliced to obtain a series of sections, with each section having a thickness of, for example, 4-5 microns. Such sectioning can be performed by first chilling the sample and slicing the sample in a warm water bath. Prior to staining of the slice and mounting on the glass slide (e.g., as described below), deparaffinization (e.g., using xylene) and/or re-hydration (e.g., using ethanol and water) of the slice may be performed.

Because the tissue sections and the cells within them are virtually transparent, preparation of the slides typically includes staining (e.g., automatically staining) the tissue sections in order to render relevant structures more visible. For example, different sections of the tissue may be stained with one or more different stains to express different characteristics of the tissue. For example, each section may be exposed to a predefined volume of a staining agent for a predefined period of time. When a section is exposed to multiple staining agents, it may be exposed to the multiple staining agents concurrently.

Each section may be mounted on a slide, which is then scanned to create a digital image that may be subsequently examined by digital pathology image analysis and/or interpreted by a human pathologist (e.g., using image viewer software). The pathologist may review and manually annotate the digital image of the slides (e.g., tumor area, necrosis, etc.) to enable the use of image analysis algorithms to extract meaningful quantitative measures (e.g., to detect and classify biological objects of interest). Conventionally, the pathologist may manually annotate each successive image of multiple tissue sections from a tissue sample to identify the same aspects on each successive tissue section.

One type of tissue staining is histochemical staining, which uses one or more chemical dyes (e.g., acidic dyes, basic dyes) to stain tissue structures. Histochemical staining may be used to indicate general aspects of tissue morphology and/or cell microanatomy (e.g., to distinguish cell nuclei from cytoplasm, to indicate lipid droplets, etc.). One example of a histochemical stain is hematoxylin and eosin (H&E). Other examples of histochemical stains include trichrome stains (e.g., Masson's Trichrome), Periodic Acid-Schiff (PAS), silver stains, and iron stains. Another type of tissue staining is immunohistochemistry (IHC, also called “immunostaining”), which uses a primary antibody that binds specifically to the target antigen of interest (also called a biomarker). IHC may be direct or indirect. In direct IHC, the primary antibody is directly conjugated to a label (e.g., a chromophore or fluorophore). In indirect IHC, the primary antibody is first bound to the target antigen, and then a secondary antibody that is conjugated with a label (e.g., a chromophore or fluorophore) is bound to the primary antibody.

Mitosis is a stage in the life cycle of a biological cell in which replicated chromosomes separate to form two new nuclei, and a “mitotic figure” is a cell that is undergoing mitosis. The prevalence of mitotic figures in a tissue sample may be used as an indicator of the prognosis of a disease, particularly in oncology. Tumors that exhibit high mitotic rates, for example, tend to have a lower prognosis than tumors that exhibit low mitotic rates, where the mitotic rate may be defined as the number of mitotic figures per a fixed number (e.g., one hundred) tumor cells. Such an indicator may be applied, for example, to various solid and hematologic malignancies. Pathologist review of a slide image (e.g., of an H&E-stained section) to determine mitotic rate may be highly labor-intensive.

### 2. Introduction

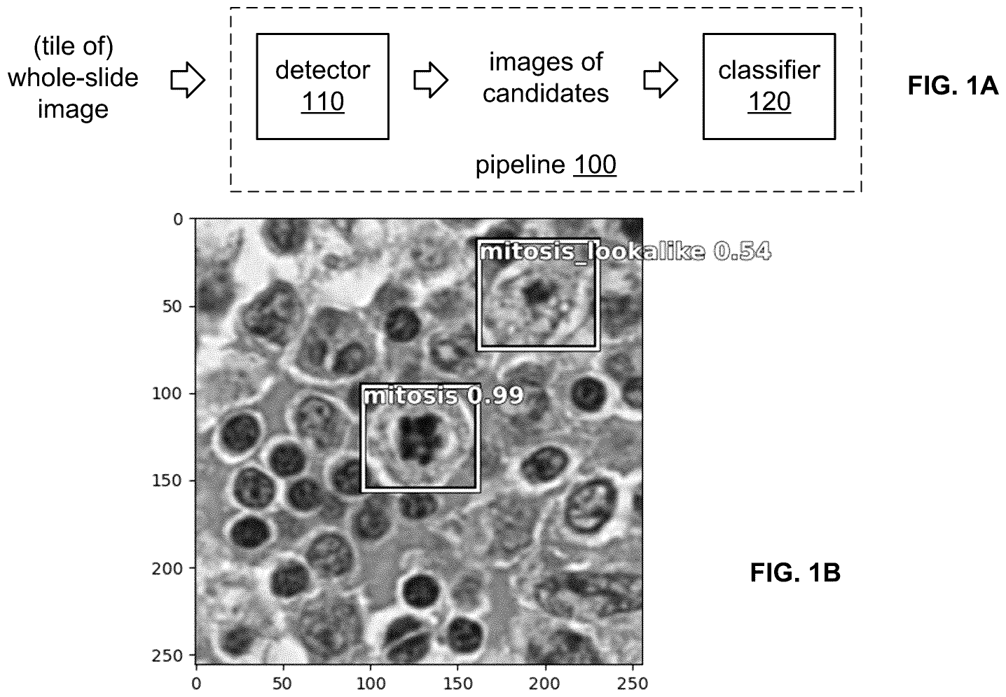

An image classification task may be configured as a process of classifying a structure that is depicted in the center region of the image. Such a task may be an element of a larger process, such as a process of quantifying the number of structures of a particular class that are depicted in a larger image (e.g., a WSI). FIG. 1A shows an example of an image processing pipeline 100 in which a large image that is expected to contain multiple depictions of a structure of a particular class (in this example, a WSI, or a tile of a WSI) is provided as input to a detector 110 (e.g., a trained neural network, such as a CNN). The detector 110 processes the large image to find the locations of structures within it that are similar to a desired class of structures, which are called “candidates.” The predicted likelihood that a candidate is actually in the desired class may be indicated by a detection score. Next, candidates with a detection score above a predefined threshold are processed by a classifier 120 (e.g., including an architecture component as described herein) in order to predict further whether each candidate is really of the desired class or is instead of one of one or more other classes (e.g., even though it may bear a high similarity to structures of the desired class). In such an application, the input to the classifier 120 may be image crops, each centered at a different one of the candidates identified by the detector 110.

A deep learning architecture component (and its variants) as described herein may be used at the ending of a classification model: for example, as a final stage of classifier 120 of pipeline 100. Such a component can be applied in a classifier on top of a feature-extraction backend, for example, although its potential and disclosed uses are not limited to only such an application. Applying such a component may improve the quality of, e.g., cell classification (for example, in comparison to standard, flattened, fully-connected ending of neural networks based on transfer learning).

An architecture component as disclosed herein may be especially advantageous for applications in which the centers of the objects to be classified (for example, individual cells) are exactly or approximately at the centers of the input images that are provided for classification (e.g., the images of candidates as indicated in FIG. 1A). Such objects may vary in some range of sizes, which can be approximately characterized by various radii.

An architecture component as disclosed herein may also be implemented to aggregate sets of output features that are generated from various radii crops. Such aggregation may cause a neural network of the architecture component to weight information from the center of an input image more heavily and to gradually lower the impact of the surrounding regions as their distance from the center of the image increases. During training, the neural network may learn to aggregate the output features according to a most beneficial distribution of importance impact.

Techniques described herein may include, for example, applying the same set of convolutional neural network operations over a spectrum of co-centered (e.g., concentric) crops of a 2D feature map, with various radii from the center of the feature map. By extension, techniques described herein also include techniques of applying the same set of convolutional neural network operations over a spectrum of co-centered (e.g., concentric) crops of a 3D feature map (e.g., as generated from a volumetric image, as may be produced by a PET or MRI scan), with various radii from the center of the feature map.

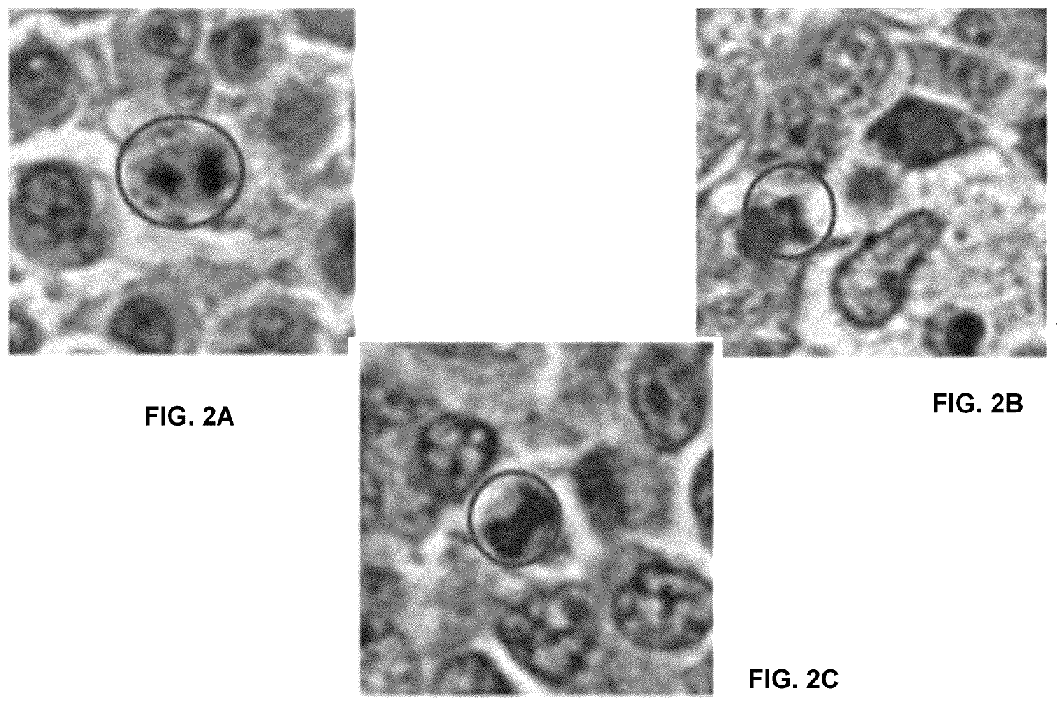

An architecture component as described herein may be applied, for example, as a part of a mitotic figure detection and classification pipeline (which may be implemented, for example, as an instance of pipeline 100 as shown in FIG. 1A). The detector may be configured to detect the locations of cells that are predicted to be mitotic figures (“candidates”). Next, candidates with a detection score above a predefined threshold may be processed by a classifier (e.g., including an architecture component as described herein) in order to predict further whether a given cell is really a mitotic figure or is instead of one of one or more other classes of cells (e.g., including one or more classes which may share high similarity to mitotic figures). In this application, the input to the classifier may be an image crop centered at the candidate identified by the detector. FIG. 1B shows an example of such an input image in which the candidate (in this case, a mitotic figure) is centered and indicated by a bounding box, and a lookalike structure of a different class is also indicated by a bounding box. FIG. 2A shows an example of another input image (e.g., as produced by a mitotic figure detector as described above) in which the candidate (in this case, a mitotic figure that is indicated by the red circle) is centered.

It may be desired to leverage this property of the input image that the region of interest (ROI) is centered within the image by training the neural network with more emphasis on analyzing the cell that is located in the center of the image crop, as opposed to analyzing the neighboring cells.

Information such as the size of the center cell and/or the relation of the center cell to its neighborhood may strongly impact the classification. A solution in which the input image is obtained by simply extracting the bounding box of the detected cell and rescaling it to a constant size may exclude such information, and such a solution may not be good enough to yield optimal results.

In contrast to focusing on the detected cell by using a bounding box having a size that may vary from one cell to another according to the size of the cell, it may be desired to take crops around the detected cell that have the same resolution and size for each detected cell. Such kind of image crops contain the neighborhood of the cell, which may contain useful context information for cell evaluation. In addition, the constant resolution of these crops from one cell to another (e.g., without the rescaling which may be required for a bounding box of varying size) enables deduction of size information of the cell.

Analysis of misclassified test samples may help to identify situations that may give rise to error. For example, it was found that test samples for which the cell ground-truth annotation was slightly off-center were more likely to be misclassified, especially if another cell was relatively closer to the center of the input image when compared with the mitosis ground truth. FIG. 2B shows an example of an input image in which the mitotic figure (indicated by the red circle) is not in the center of the image.

This problem can occur in real scenarios in which, for example, the detected candidate is slightly off-centered. One solution for the problem is to apply some degree of proportional random position shift in the training, which may help to expand the model's attention to include cells that are in some vicinity of the center, rather than being limited only to cells that are exactly in the center.

Such a solution may be difficult to calibrate, however, because random position shifts may give rise to new kinds of misclassification. One such result may be that the model is not always focused on the most central cell. For example, when a mitotic figure is surrounded by several tumor cells, it tends to be misclassified as a tumor cell. Such misclassification may occur because features of neighboring cells have a higher impact on the final output, despite the fact that the target cell that is actually to be classified is closer to the center. FIG. 2C shows an example of an input image in which a mitotic figure (indicated by the red circle) is surrounded by several tumor cells.

Therefore, a more reliable way of configuring the neural network to assign greater weight to the cell that is the closest to the center of the input image may be desired. One solution is to prepare a hard-coded mask of importance (with values that are weights in the range of, for example, from 0 to 1) and multiply the relevant information (either the input image or some of feature maps) by such a mask (e.g., pixel by pixel). The relevant information can either be an input image or one or more intermediate feature-maps generated by the neural network from an input image.

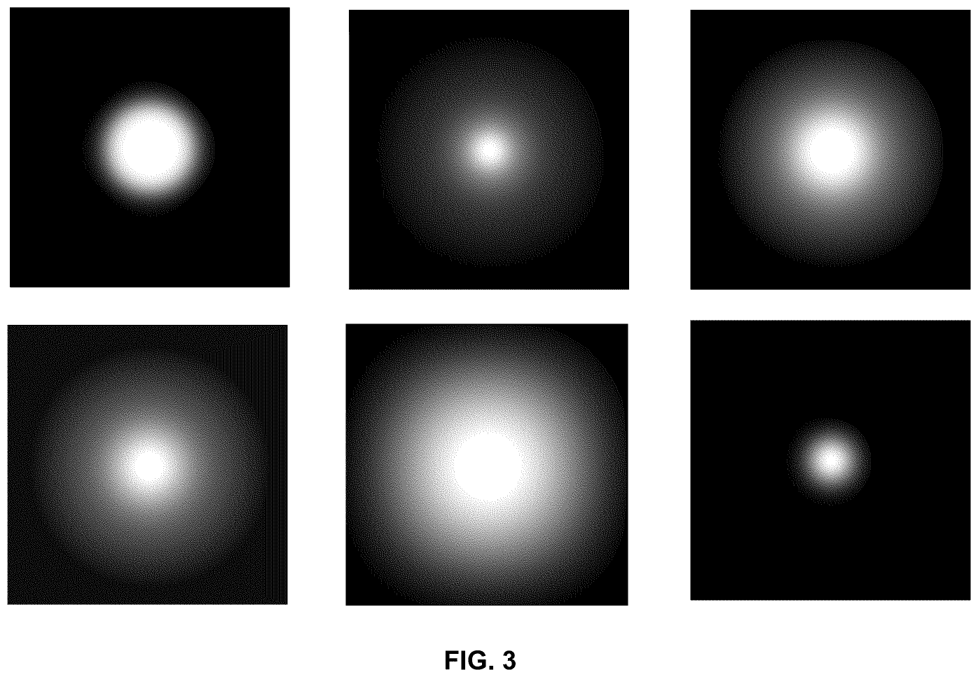

FIG. 3 shows six different examples of an importance mask. As a result of multiplying with such masks, a non-homogenous convolution output is introduced, causing the neural network to account for the distance from the center and make deductions from it.

However, using an importance mask may not be an optimal approach to causing the neural network to assign greater importance weights to the center of the input image. The input images may depict cells of various sizes, and the quality of making centered detections may vary among different detector networks and thus may depend upon the particular detector network being used. A hard-coded mask selection may not be universally suited for all situations, and a self-calibrating mechanism may be desired instead.

Another concern with using an importance mask is that multiplying the input image directly with a mask may result in a loss of information about the neighborhood and/or a loss of homogeneity on inputs of very early convolutional layers. Early convolutional layers tend to extract very basic features of similar image elements in the same way, independent of their location within the image. Early multiplication by a mask may reduce a similarity among such image elements, which might be harmful to pattern recognition of the neighborhood topology.

A baseline approach for transfer learning is to add classical global average pooling, followed by one or two fully connected layers and softmax activation, after the feature extraction layers from a model that has been pre-trained on a large dataset (e.g., ImageNet). Global average pooling, however, may have the problem that it treats information from every region of an image as equally important and thus does not leverage prior knowledge that may be available in this context (e.g., that the target objects are mostly close to the image center). Approaches as described herein include modifying a classical approach of transfer-learning with a customization that leverages the centralized location of the most important object.

Techniques as described herein (e.g., techniques that use radius convolution among others) may be used to implement an architecture component in which a neural network of the component self-calibrates a distribution of importance among regions that are at various distances from the image center. In contrast to the approach of multiplying an input image by a fixed importance mask, techniques as described herein may avoid the loss of important information about the neighborhood of the cell. In addition, techniques as described herein may allow low-level convolutions to work in the same way on different (possibly all) regions of the input image: for example, by applying heterogeneity depending on radius only in a late stage of the neural network. Experimental results show that applying a technique as described herein (e.g., a technique that includes radius convolution over the feature maps extracted by a EfficientNet backbone) may help a neural network to reach higher accuracy as opposed to the baseline.

### 3. Techniques Using Concentric Cropping

As noted above, a process that crops an input image down to the target object and then scales the crop up to the input size of the classifier may lead to a loss of information about the target's size and neighborhood. In an approach as described in more detail below, crops of constant resolution may be generated such that the target object is close to the image center (e.g., is represented at least partially in each crop) and the surrounding neighborhood of the object is also included. Such an approach may be implemented to leverage both information about the size of the target object and information about the relation of the target object to its neighborhood.

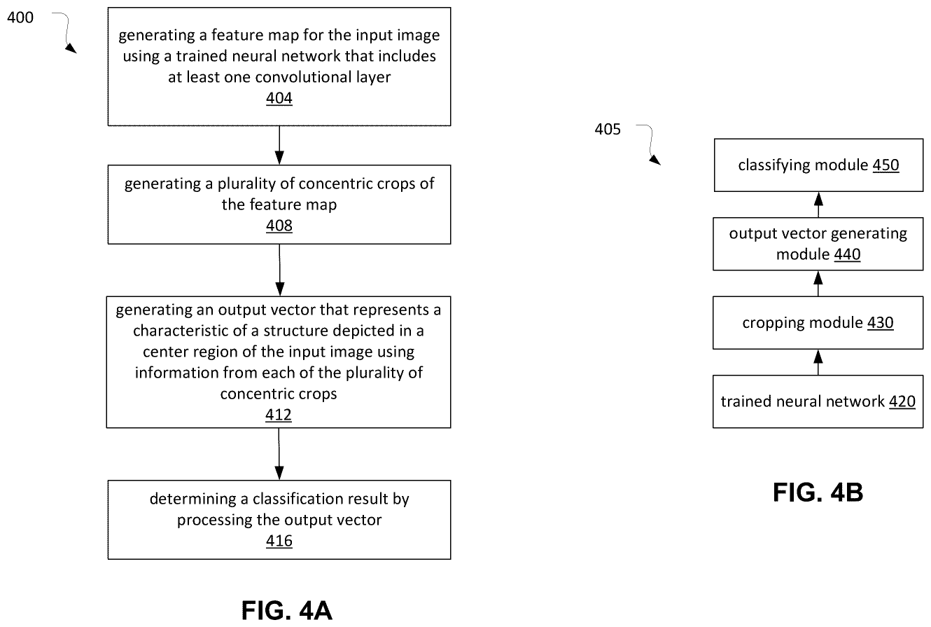

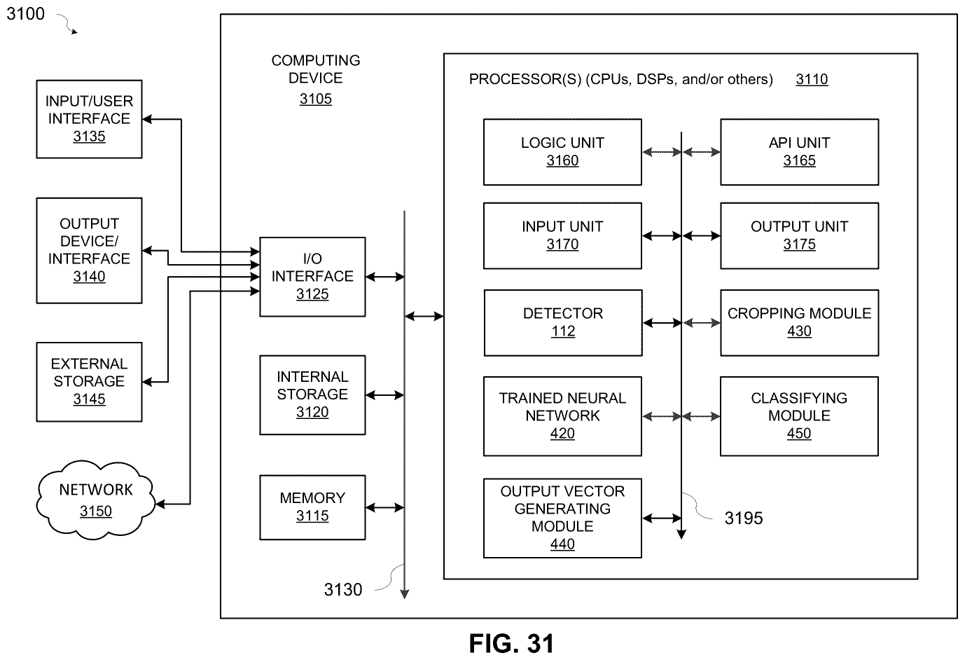

FIG. 4A illustrates a flowchart for an exemplary process 400 to classify an input image. Process 400 may be performed using one or more computing systems, models, and networks (e.g., as described herein with respect to FIG. 31). With reference to FIG. 4A, a feature map for the input image is generated at block 404 using a trained neural network that includes at least one convolutional layer. At block 408, a plurality of concentric crops of the feature map is generated. For each of the plurality of concentric crops, a center of the feature map may be coincident with a center of the crop. At block 412, an output vector that represents a characteristic of a structure depicted in a center region of the input image using information from each of the plurality of concentric crops is generated. The structure depicted in the center region of the input image may be, for example, a structure to be classified. The structure depicted in the center region of the input image may be, for example, a biological cell. At block 416, a classification result is determined by processing the output vector. The classification result may predict, for example, that the input image depicts a mitotic figure.

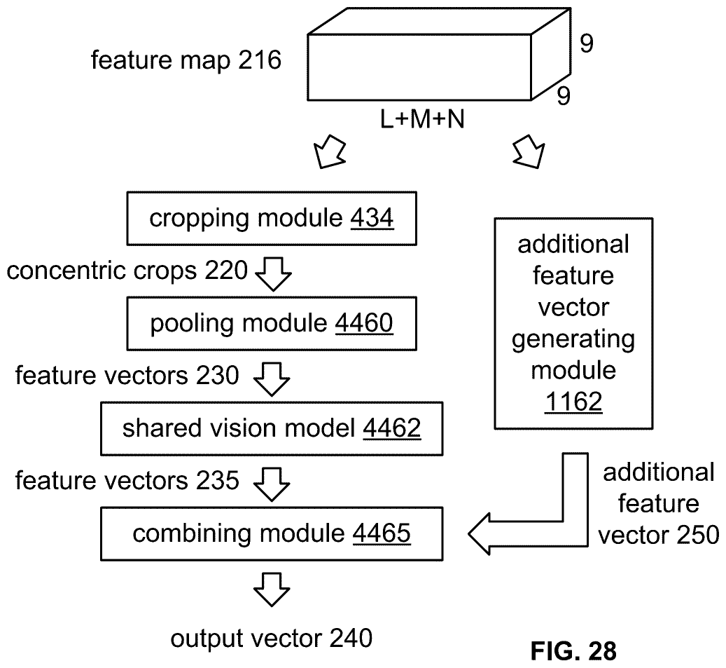

FIG. 4B shows a block diagram of an exemplary architecture component 405 for classifying an input image. Component 405 may be implemented using one or more computing systems, models, and networks (e.g., as described herein with respect to FIG. 28). With reference to FIG. 4B, a trained neural network 420 that includes at least one convolutional layer is to receive an input image and to generate a feature map for the input image. A cropping module 430 is to receive the feature map and to generate a plurality of concentric crops of the feature map. For each of the plurality of concentric crops, a center of the feature map may be coincident with a center of the crop. An output vector generating module 440 is to receive the plurality of concentric crops and to generate an output vector that represents a characteristic of a structure depicted in a center region of the input image using the plurality of concentric crops. The structure depicted in the center region of the input image may be, for example, a structure to be classified. The structure depicted in the center region of the input image may be, for example, a biological cell. A classifying module 450 is to determine a classification result by processing the output vector. The classification result may predict, for example, that the input image depicts a mitotic figure.

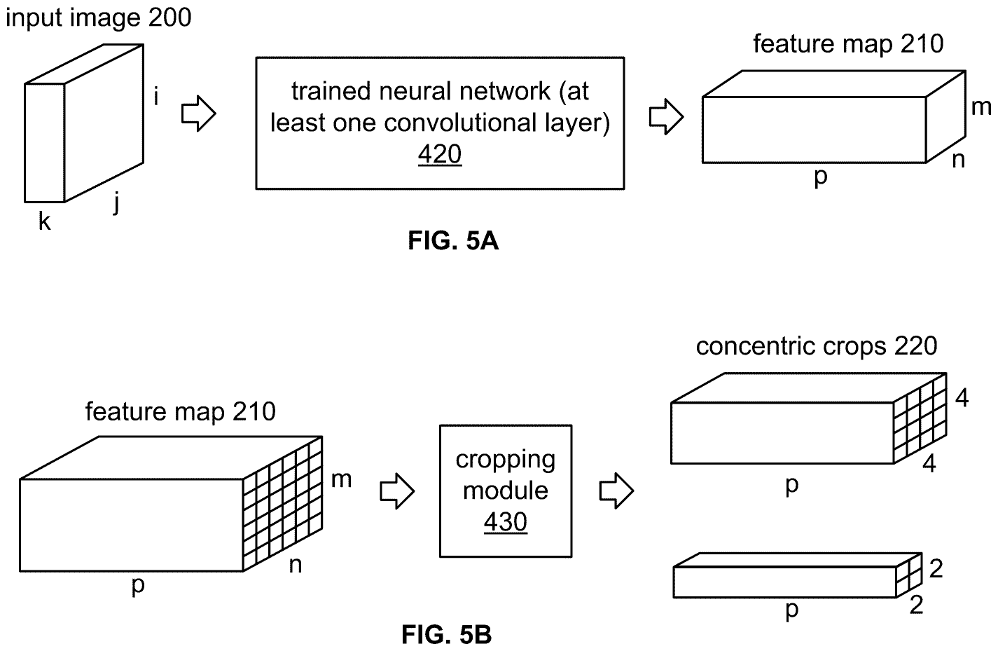

FIG. 5A shows an example of actions of block 404 in which a feature map 210 (e.g., a 2D feature map) for an input image 200 is generated (e.g., extracted from the input image 200) using the trained neural network 420, which includes at least one convolutional layer. The trained neural network 420 may be, for example, a pre-trained backbone of a deep convolutional neural network (CNN). Particular examples of such a backbone that may be used include, for example, a residual network (ResNet) an implementation of a MobileNet model, or an implementation of an EfficientNet model (e.g., any among the range of models from EfficientNet-B0 to EfficientNet-B7), but any other neural network backbone (whether according to, e.g., another known model or even a custom model) that is configured to extract an image feature map may be used. A backbone (or backend) of a CNN is defined as a feature extraction portion of the network. The backbone may include all of the CNN except for the final layers (e.g., the fully connected layer and the activation layer), or the backbone may exclude other layers of one or more final stages of the network as well (e.g., global average pooling). In one example, the feature map 210 is the last 2D feature map generated by the network 420 before global average pooling.

The trained neural network 420 may be trained on a large dataset of images (e.g., more than ten thousand, more than one hundred thousand, more than one million, or more than ten million). The large dataset of images may include images that depict non-biological structures (e.g., cars, buildings, manufactured objects). Additionally or alternatively, the large dataset of images may include images that do not depict a biological cell (e.g., images that depict animals). The ImageNet project (https://www.image-net.org) is one example of a large dataset of images which includes images that depict non-biological structures and images that do not depict a biological cell. (A dataset of images which includes images that do not depict a biological cell is also called a “generic dataset” herein.) A semi-supervised learning technique, such as Noisy Student training, may be used to increase the size of a dataset for training and/or validation of the network 420 by learning labels for previously unlabeled images and adding them to the dataset. Optional further training of the network 420 within component 405 (e.g., fine-tuning) is also contemplated.

Training of the detector and/or classifier models (e.g., training of network 420) may include augmenting the set of training images. Such augmentations may include random variations of color (e.g., rotation of hue angle), size, shape, contrast, brightness, and/or spatial translation (e.g., to increase robustness of the trained model to miscentering) and/or rotation. In one example of such a random augmentation, images of the training set for the classifier network may be slightly proportionally position-shifted along the x and/or y axis (e.g., by up to ten percent of the image size along the axis of translation). Such augmentation may provide better adaptation to slight imperfections of the detector network, as these imperfections might cause the detected cell candidate to be slightly off-centered in the input image that is provided to the classifier. Training of the classifier model may include pre-training a backbone neural network of the model (e.g., on a dataset of general images, such as a dataset that includes images depicting objects that will not be seen during inference), then freezing the initial layers of the model while continuing to train final layers (e.g., on a dataset of specialized images, such as a dataset of images depicting objects of the class or classes to be classified during inference).

The input image 200 may be produced by a detector stage (e.g., another trained neural network) and may be, for example, a selected portion of a WSI, or a selected portion of a tile of a WSI. The input image 200 may be configured such that a center of the input image is within a region of interest. For example, the input image 200 may depict a biological cell of interest and may be configured such that the depiction of the cell of interest is centered within the input image.

In the example of FIG. 5A, the size of the input image 200 is (i×j) pixels (arranged in i rows and j columns) by k channels, and the size of the feature map 210 is (m×n) spatial elements (arranged in m rows and n columns) by p channels (e.g., features). Exemplary values of i and j may include, for example, 128 or 256. For example, the input image 200 may be a 128×128—or 256×256-pixel tile of a larger image (e.g., as produced by a detector network as described above). Exemplary values of k may include three (e.g., for an image in a three-channel color space, such as RGB, YCbCr, etc.). Exemplary values of m and n may include, for example, any integer from 7 to 33, and the value of m may be but is not necessarily equal to the value of n. Exemplary values of p may include, for example, integers in the range of from 10 to 200 (e.g., in the range of from 30 to 100).

FIG. 5B shows an example of actions of block 408 in which the plurality 220 of concentric crops of the feature map 210 is generated using a cropping operation (in this example, as performed by a cropping module 430). It may be desired to configure the cropping operation such that the center of each of the plurality 220 of concentric crops in the spatial dimensions (e.g., the dimensions of size 2 and 4 in the example of FIG. 5B) coincides with the center of the feature map 210 in the spatial dimensions (e.g., the dimensions of size m and n in the examples of FIGS. 5A and 5B). For a square-shaped N×N feature map that is cropped in the center, for example, crops of any one or more of the following square sizes may be obtained: N×N, (N−2)×(N−2), (N−4)×(N−4) . . . down to either 2×2 or 1×1 (depending if N is even or odd). In the particular example shown in FIG. 5B, m is equal to n and is even (e.g., divisible by two), the number of the plurality 220 of concentric crops is two, and the dimensions of the concentric crops is (2×2)×p and (4×4)×p. In other examples, m and/or n may be odd, and/or the number of the plurality 220 of concentric crops may be three, four, five, or more.

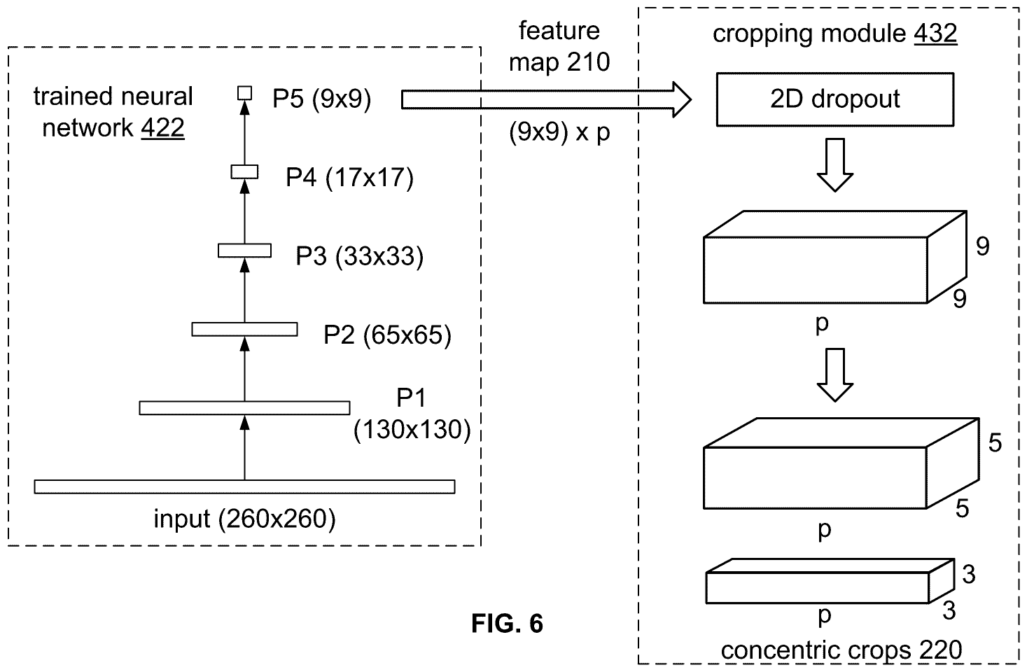

FIG. 6 shows an example of actions of block 404 as applied to an configuration in which the trained neural network 420 of component 405 is implemented as an instance 422 of an EfficientNet-B2 backbone; the input image has a size of (260×260) pixels (possibly rescaled from another size, such as 128×128 or 256×256); and the feature map 210 has a size of (9×9) spatial elements×p features. The feature levels P1 to P5 and the corresponding feature resolutions at each level are also shown. FIG. 6 also shows an example of actions of block 408 in which an implementation 432 of cropping module 430 of component 405 performs a 2D dropout operation on the feature map 210 before cropping the resulting feature map to produce the plurality 220 of concentric crops (in this example, crops having spatial dimensions (5×5) and (3×3)). It is understood that an equivalent result may be obtained by performing such a 2D dropout operation within the network 422 instead (e.g., performing the 2D dropout operation on the output of level P5 of network 422 to produce feature map 210).

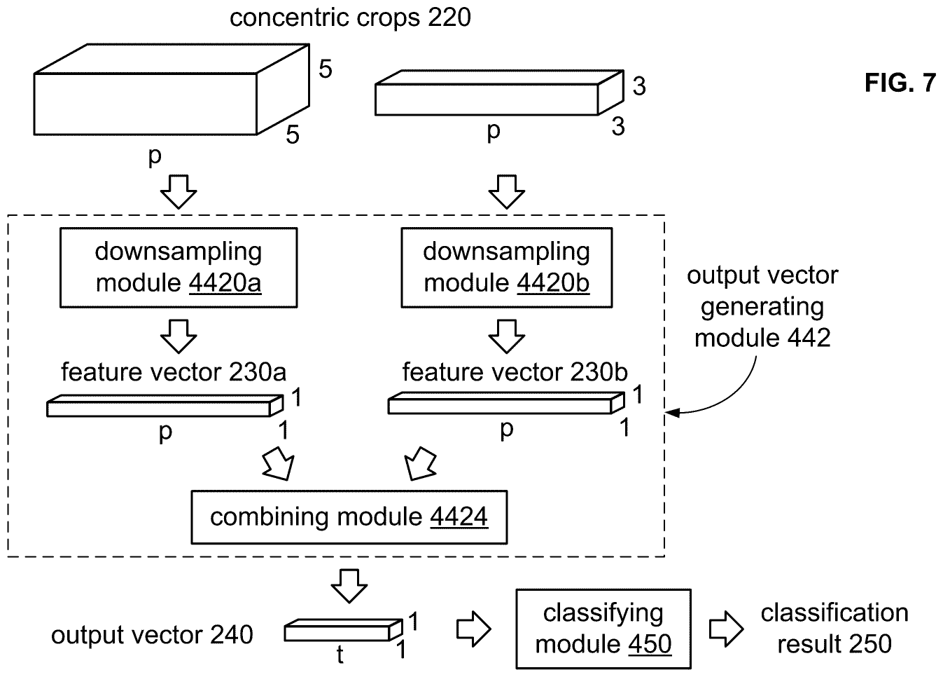

FIG. 7 shows an example of actions of block 412 as applied to a configuration in which an implementation 442 of the output vector generating module 440 of component 405 includes downsampling modules 4420a,b and a combining module 4424. Each downsampling module 4420a,b downsamples a corresponding one of the plurality 220 of concentric crops (in this example, the crops shown in FIG. 6) to produce a downsampled feature map, and combining module 4424 combines the downsampled feature maps to produce an output vector 240. In this particular example, the downsampled feature maps are feature vectors 230a,b, and it may be desired to configure the downsampling modules 4420a,b such that the dimensions of each feature vector 230a,b are (1×1)×p. Each of the downsampling modules 4420a,b may downsample the corresponding concentric crop by performing, for example, a global pooling operation (e.g., a global average pooling operation or a global maximum pooling operation). Examples of the combining module 4424 are discussed in further detail below.

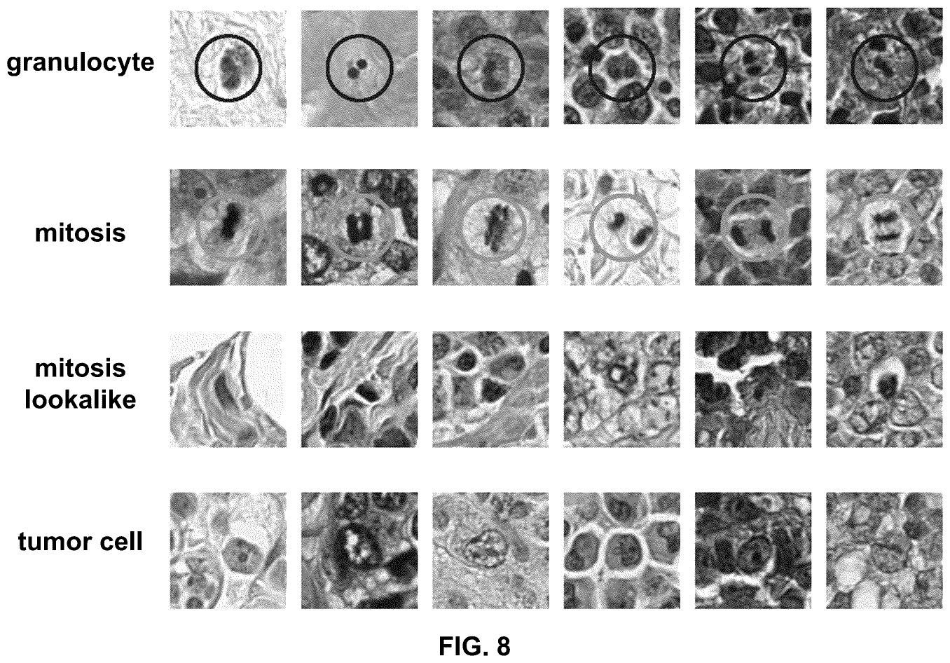

Any set of operations may follow generation of the output vector 240: any number of layers, for example, or even just one fully connected layer to derive the final prediction score. FIG. 7 also shows an example of actions of block 416 in which the classifying module 450 of component 405 processes the output vector 240 to determine a classification result 250. The classifying module 450 may process the output vector 240 using, for example, a sigmoid or softmax activation function. In a particular application for mitosis classification, the following four classes may be used: granulocytes, mitotic figures, look-alike cells (non-mitotic cells that resemble mitotic figures), and tumor cells (as shown, for example, in FIG. 8).

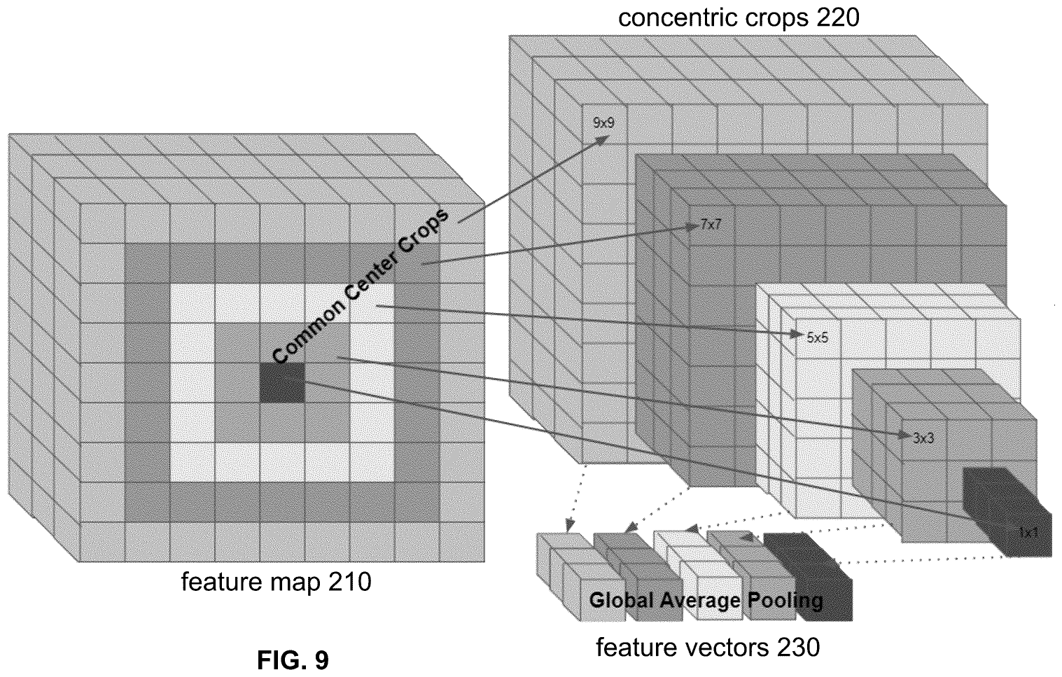

FIG. 9 shows a particular example of an application of process 400 in which the size of the feature map 210 is (9×9)×3; the number of the plurality 220 of concentric crops is five; the sizes of the plurality 220 of concentric crops are (9×9)×p, (7×7)×p, (5×5)×p, (3×3)×p, and (1×1)×p; and each of the feature vectors 230 is produced by performing global average pooling on a corresponding one of the plurality 220 of concentric crops (e.g., each of the downsampling modules 4420 performs global average pooling). Alternatively, one or more (possibly all) of the feature vectors 230 may be produced by performing global max pooling on a corresponding one of the plurality 220 of concentric crops (e.g., one or more (possibly all) of the downsampling modules 4420 performs global max pooling). In a further alternative, both types of pooling may be performed, in which case the resulting pairs of feature vectors may be concatenated.

The combining module 4424 may be implemented to aggregate the set of feature vector instances that are generated (e.g., by pooling or other downsampling operations) from the concentric crops. One example of aggregation is implementation of either a weighted sum or a weighted average. Such aggregation may be achieved by multiplying each output feature vector by its individual weight and then adding the weighted feature vectors together. This result is a weighted sum. Further dividing it by the sum of the weights gives a weighted average, but the division step is optional, as the appropriate weights may be learned through the training process anyway so that a similar practical functionality can be achieved.

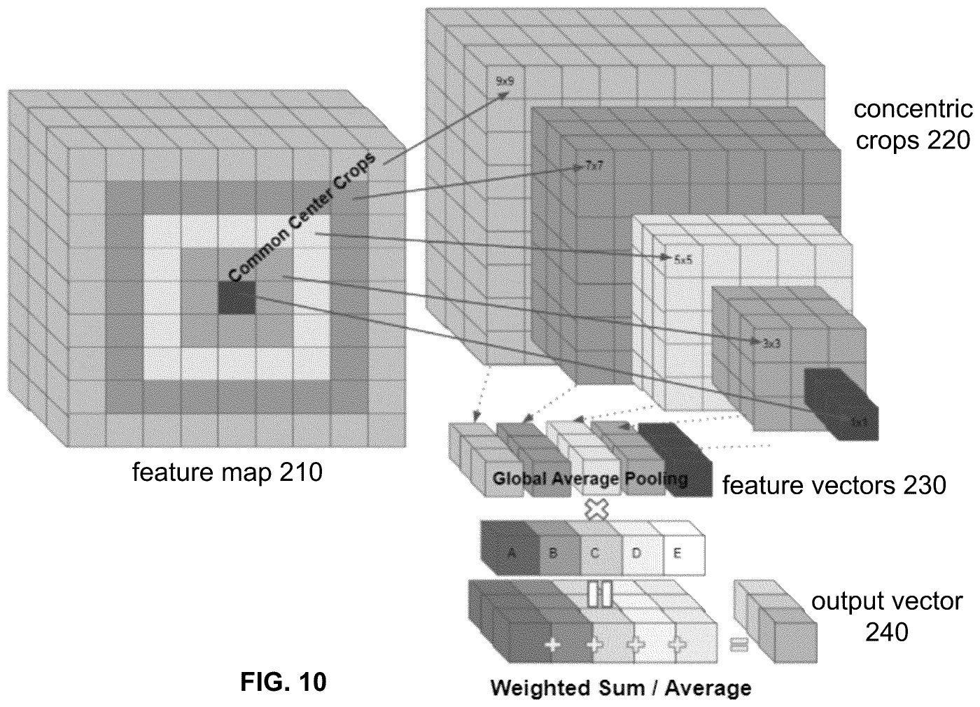

Such an aggregation solution may be implemented, for example, by allocation of a vector of weights that participates in training. The trained weights may learn the optimal distribution of the importance of the feature vectors that characterize regions of different radii. In the example of FIG. 10 as discussed below, a vector with values noted as A,B,C,D,E is a vector of importance weights.

FIG. 10 shows the example of FIG. 9 in which the output vector 240 is calculated (e.g., in block 412 or by the combining module 4424) as a weighted sum (or a weighted average) of the feature vectors 230. In this example, each of the five feature vectors 230 is weighted by a corresponding one of the weights A, B, C, D, and E, which may be trained parameters.

Aggregation of feature vectors generated from a feature map (e.g., feature vectors generated from a plurality of concentric crops as described above) may include applying a trained model (also called a “shared model,” “shared-weights model,” or “shared vision model”) separately to each of the feature vectors to be aggregated. For example, for each of a plurality of concentric crops of a feature map at different radii, a trained vision model may be applied along a corresponding feature map or vector that is derived from the crop as described above, which may be described as an example of “radius convolution.” Here, the “shared model” may be implemented as a solution in which the same set of neural network layers with exactly the same weights is applied to different inputs (e.g., as in a “shared vision model” used to process different input images in Siamese and triplet neural networks). For example, the trained shared-weights model may apply the same set of equations, for each of the plurality of concentric crops, over a corresponding feature map or vector that is derived from the crop. The layers in the shared vision model may vary from one another in their number, shape, and/or other details.

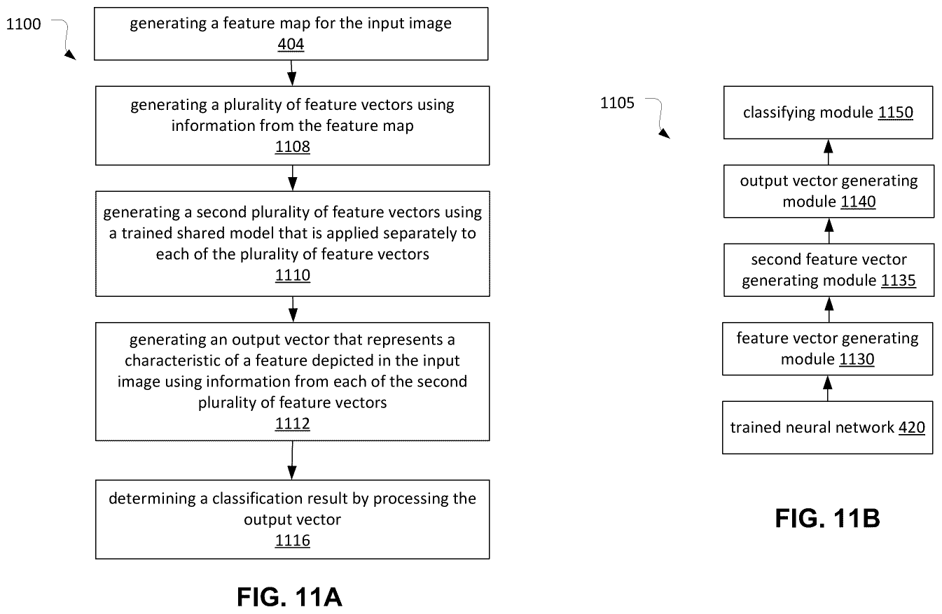

FIG. 11A illustrates a flowchart for another exemplary process 1100 to classify an input image. Process 1100 may be performed using one or more computing systems, models, and networks (e.g., as described herein with respect to FIG. 31). With reference to FIG. 11A, process 1100 includes an instance of block 404 as described herein. At block 1108, a plurality of feature vectors is generated using information from the feature map. For example, a plurality of concentric crops of the feature map may be generated at block 1108 (e.g., as described above with reference to block 408), and for each of a plurality of concentric crops generated at block 1108, a center of the feature map may be coincident with a center of the crop. At block 1110, a second plurality of feature vectors is generated using a trained model that is applied separately to each of the plurality of feature vectors generated at block 1108. At block 1112, an output vector that represents a characteristic of a structure depicted in the input image (e.g., in a center region of the input image) using information from each of the second plurality of feature vectors is generated. The structure depicted in the input image may be, for example, a structure to be classified. The structure depicted in the input image may be, for example, a biological cell. At block 1116, a classification result is determined by processing the output vector (e.g., as described above with reference to block 416). The classification result may predict, for example, that the input image depicts a mitotic figure.

FIG. 11B shows a block diagram of another exemplary architecture component 1105 for classifying an input image. Component 1105 may be implemented using one or more computing systems, models, and networks (e.g., as described herein with respect to FIG. 31). Component 1105 may be implemented to include a neural network that has two sub-networks-a first neural network that is an instance of trained neural network 420, and a second neural network that is a trained shared model as described herein—where the second neural network is configured to process an input that is based on an output latent space vector (feature map) generated by the first neural network. With reference to FIG. 11B, component 405 includes an instance of trained neural network 420 (e.g., backbone 422) as described herein to generate a feature map. A feature vector generating module 1130 is to generate a plurality of feature vectors using the feature map. For example, feature vector generating module 1130 may be to generate a plurality of concentric crops of the feature map (e.g., as an instance of cropping module 430 as described above), and for each of a plurality of concentric crops generated by feature vector generating module 1130, a center of the feature map may be coincident with a center of the crop. A second feature vector generating module 1135 is to generate a second plurality of feature vectors using a trained model (e.g., a second trained neural network) that is applied separately to each of the plurality of feature vectors generated by module 1130. An output vector generating module 1140 is to generate an output vector that represents a characteristic of a structure depicted in the input image (e.g., in a center region of the input image) using the second plurality of feature vectors. The structure depicted in the input image may be, for example, a structure to be classified. The structure depicted in the input image may be, for example, a biological cell. A classifying module 1150 is to determine a classification result by processing the output vector. The classification result may predict, for example, that the input image depicts a mitotic figure.

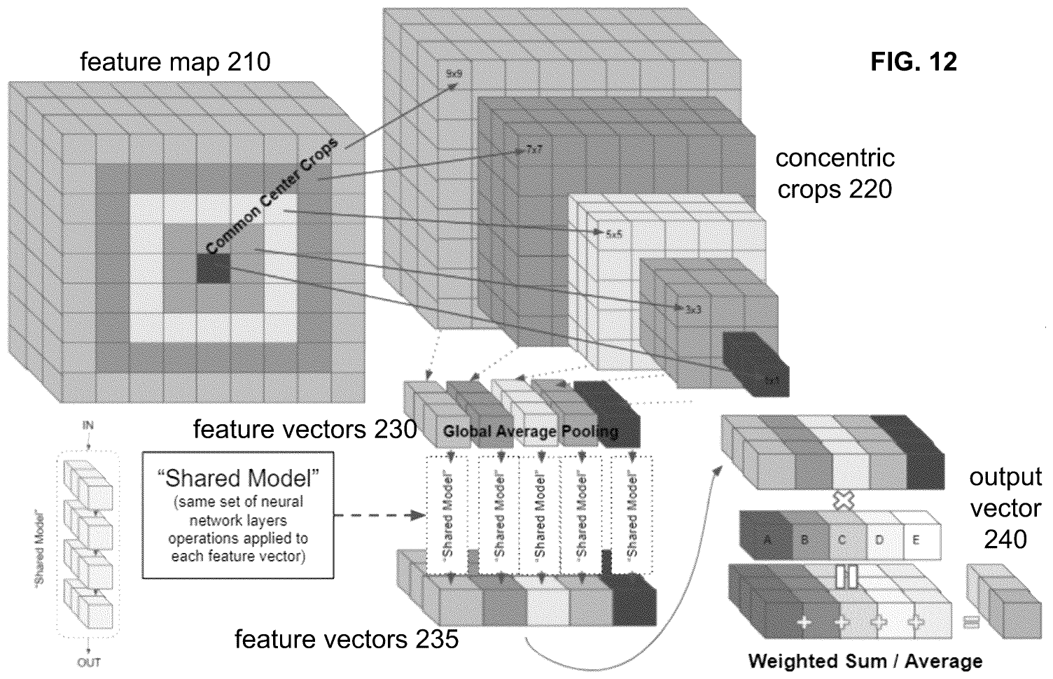

FIG. 12 shows the example of FIG. 9 in which a shared model is applied independently to each of the plurality of feature vectors 230 (e.g., at block 1112 or by second feature vector generating module 1135) to obtain a second plurality of feature vectors 235. This example also shows calculating the output vector 240 (e.g., at block 1112 or by the output vector generating module 1140) from the second plurality of feature vectors 235 returned by the shared model by applying self-adjusting aggregation (in this example, by using a weighted sum as described above with reference to FIG. 10).

Another example of aggregation may include concatenating the output feature vectors into a feature table and performing a set of 1D convolutions that exchange information between feature vectors coming from crops of neighboring radii. Such convolutions may be performed in several layers: for example, until a flat vector with information exchanged between all radii has been reached. In this way, the training process may learn relations between neighboring radii. Such a technique in which sets of operations are convolved over a changing spectrum (e.g., a spectrum of various radii from the center of the feature map) may be described as another example of “radius convolution.”

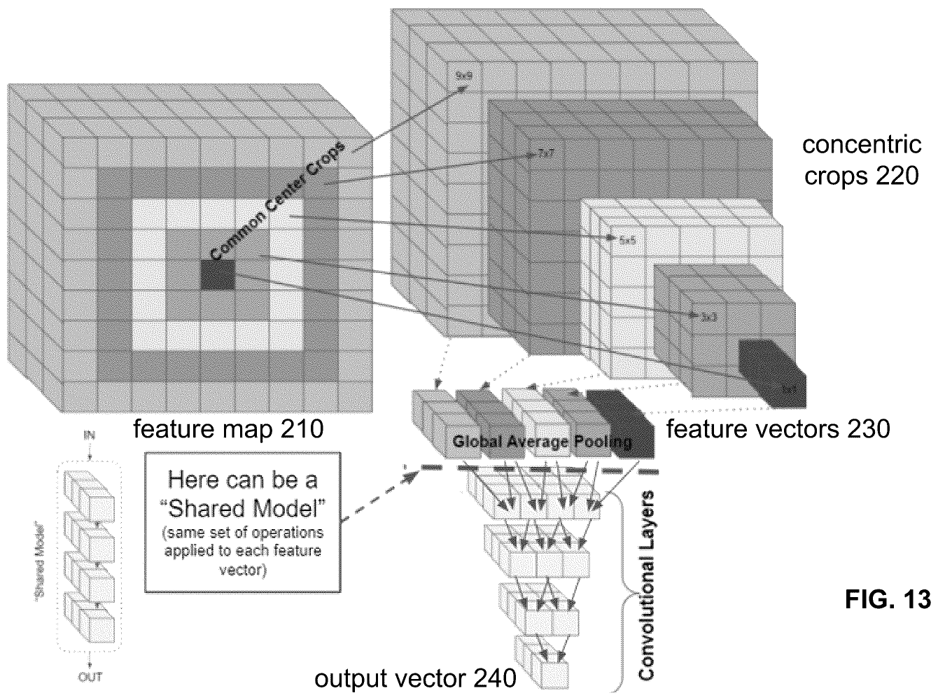

FIG. 13 shows the example of FIG. 9 in which one or more convolutional layers are applied to adjacent pairs of the feature vectors 230 (e.g., at block 1112 or by the output vector generating module 1140). In a further example as also shown in FIG. 13, the one or more convolutional layers may be applied to adjacent pairs of feature vectors that are a result of applying a shared model independently to each of the feature vectors 230.

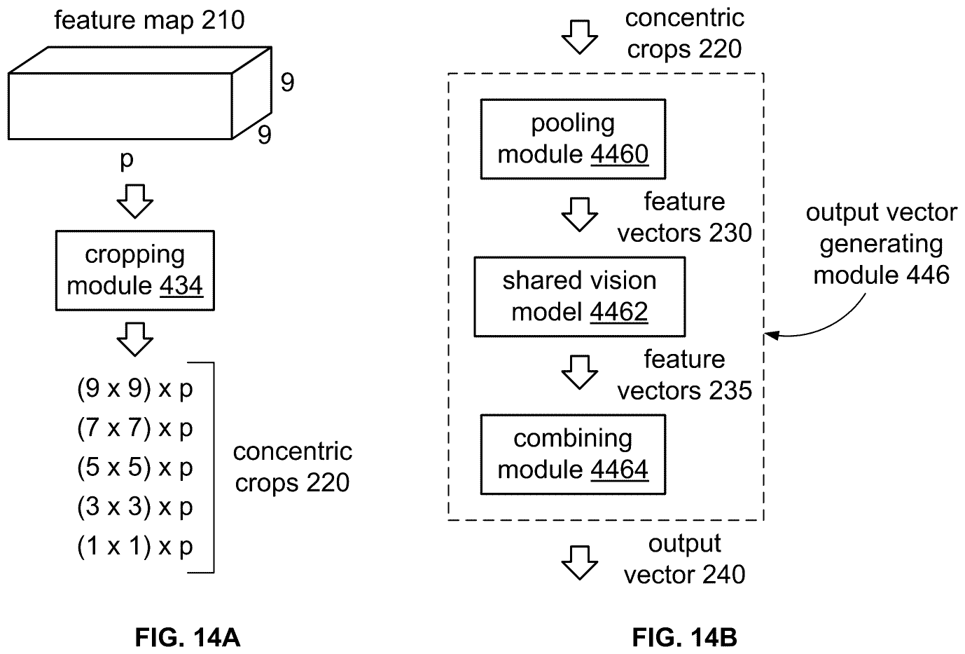

FIG. 14A shows an implementation 434 of cropping module 430 that is to produce the plurality 220 of concentric crops as five concentric crops having the spatial dimensions (1×1), (3×3), (5×5), (7×7), and (9×9). In this example, the feature map 210 of size (9×9) spatial elements×p channels (e.g., features) is included as one of the plurality 220 of concentric crops.

FIG. 14B shows a block diagram of an implementation 446 of output vector generating module 440 that includes a pooling module 4460, a shared vision model 4462, and a combining module 4464. Pooling module 4460 is to produce the feature vectors 230 by performing a pooling operation (e.g., global average pooling) on each of the plurality 220 of concentric crops. Shared vision model 4462 (e.g., a second trained neural network of the architecture component 405) is to produce the plurality 235 of second feature vectors by applying the same trained model independently to each of the plurality 230 of feature vectors. In one example, the trained model is implemented as three fully connected layers, each layer having sixteen neurons.

Combining module 4464 is to produce the output vector 240 using information from each of the plurality 235 of second feature vectors. For example, combining module 4464 may be implemented to calculate a weighted average (or weighted sum) of the plurality 235 of second feature vectors. Combining module 4464 may also be implemented to combine (e.g., to concatenate and/or add) the weighted average (or weighted sum, or a feature vector that is based on information from such a weighted average or weighted sum) with one or more additional feature vectors and/or to perform additional operations, such as dropout and/or applying a dense (e.g., fully connected) layer.

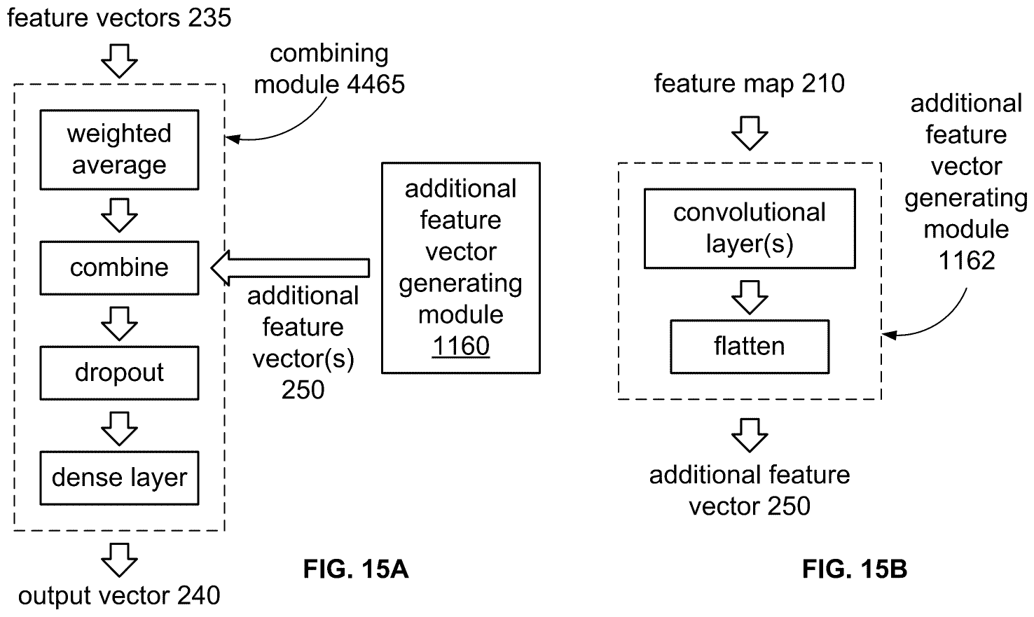

FIG. 15A shows a block diagram of such an implementation 4465 of combining module 4464. Module 4465 is to calculate a weighted average of the plurality 235 of second feature vectors, to combine (e.g., to concatenate) the weighted average with one or more additional feature vectors 250 (e.g., as generated by an optional additional feature vector generating module 1160 of architecture component 405), and to perform a dropout operation on the combined vector, followed by a dense layer, to produce the output vector 240.

FIG. 15B shows a block diagram of an implementation 1162 of additional feature vector generating module 1160. Module 1162 is to generate the additional feature vector 250 by applying three layers of 3×3 convolutions (each layer having sixteen neurons) to the feature map 210 and flattening the resulting map.

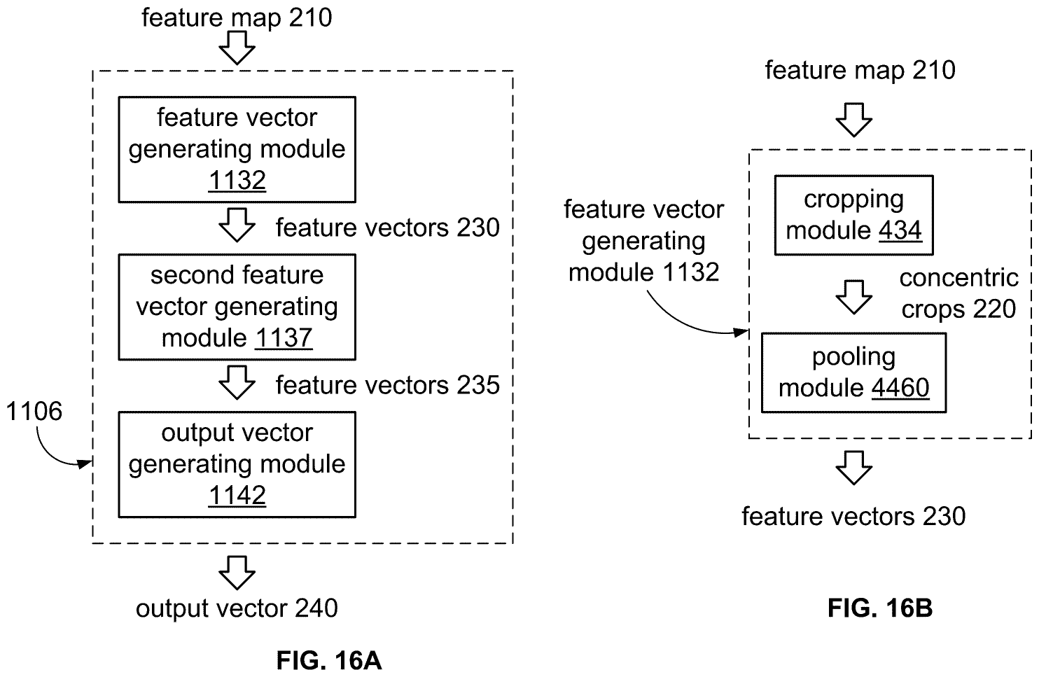

FIG. 16A shows a block diagram of an implementation 1106 of architecture component 1105 that includes an implementation 1132 of feature vector generating module 1130, an implementation 1137 of second feature vector generating module 1135 (e.g., as an instance of shared vision model 4462 as described herein), and an implementation 1142 of output vector generating module 1140. Output vector generating module 1140 may be implemented, for example, as an instance of combining module 1165 as described herein. In such case, combining module 1165 may be to combine the weighted average (or weighted sum, or a feature vector that is based on information from such a weighted average or weighted sum) with one or more additional feature vectors as generated, for example, by an optional instance of additional feature vector generating module 1132 of architecture component 1105. FIG. 16B shows a block diagram of feature vector generating module 1132, which includes instances of cropping module 434 and pooling module 447 as described above.

### 4. Techniques Using Mixed Training

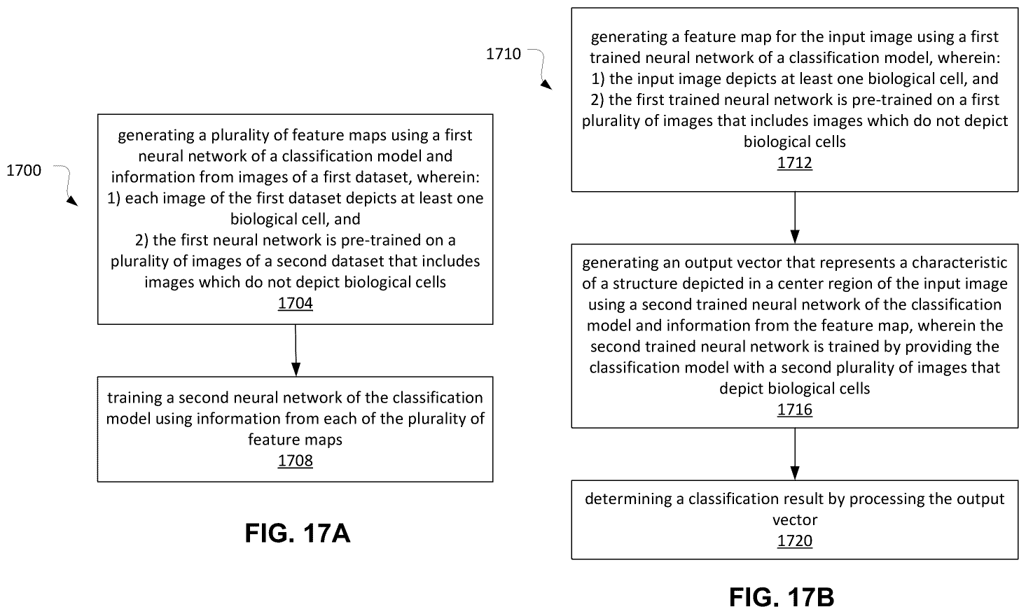

FIG. 17A illustrates a flowchart for an exemplary process 1700 to train a classification model that includes a first neural network and a second neural network. Process 1700 may be performed using one or more computing systems, models, and networks (e.g., as described herein with respect to FIG. 31). With reference to FIG. 17A, a plurality of feature maps is generated at block 1704 using a first neural network of a classification model and information from images of a first dataset. Each image of the first dataset may depict at least one biological cell. The first neural network may be pre-trained on a plurality of images of a second dataset that includes images which do not depict biological cells (e.g., ImageNet or another generic dataset). The first neural network may be, for example, an implementation of network 420 (e.g., backbone 422) as described herein, which may be to generate each of the plurality of feature maps (as an instance of feature map 210) from a corresponding image of the first dataset (as input image 200). At block 1708, a second neural network of the classification model is trained using information from each of the plurality of feature maps. The second neural network may be, for example, an implementation of a shared vision model (e.g., shared vision model 4462) as described herein.

FIG. 17B illustrates a flowchart for another exemplary process 1710 to classify an input image. Process 1710 may be performed using one or more computing systems, models, and networks (e.g., as described herein with respect to FIG. 31). With reference to FIG. 17B, a feature map is generated at block 1712 using a first trained neural network of a classification model. The input image may depict at least one biological cell, and the first trained neural network may be pre-trained on a first plurality of images that includes images which do not depict biological cells (e.g., ImageNet or another generic dataset). The first neural network may be, for example, an implementation of network 420 (e.g., backbone 422) as described herein, and the feature map may be an instance of feature map 210 as described herein.

At block 1716, an output vector that represents a characteristic of a structure depicted in a center region of the input image is generated, using a second trained neural network of the classification model and information from the feature map. The second trained neural network may be, for example, an implementation of a shared vision model (e.g., shared vision model 4462) as described herein. The second trained neural network may be trained by providing the classification model with a second plurality of images that depict biological cells. Block 1716 may be performed by, for example, modules of architecture component 405 or 1105 as described herein. The structure depicted in the center region of the input image may be, for example, a structure to be classified. The structure depicted in the center region of the input image may be, for example, a biological cell. At block 1720, a classification result is determined by processing the output vector. The classification result may predict, for example, that the input image depicts a mitotic figure.

5. Backend variations: encoder

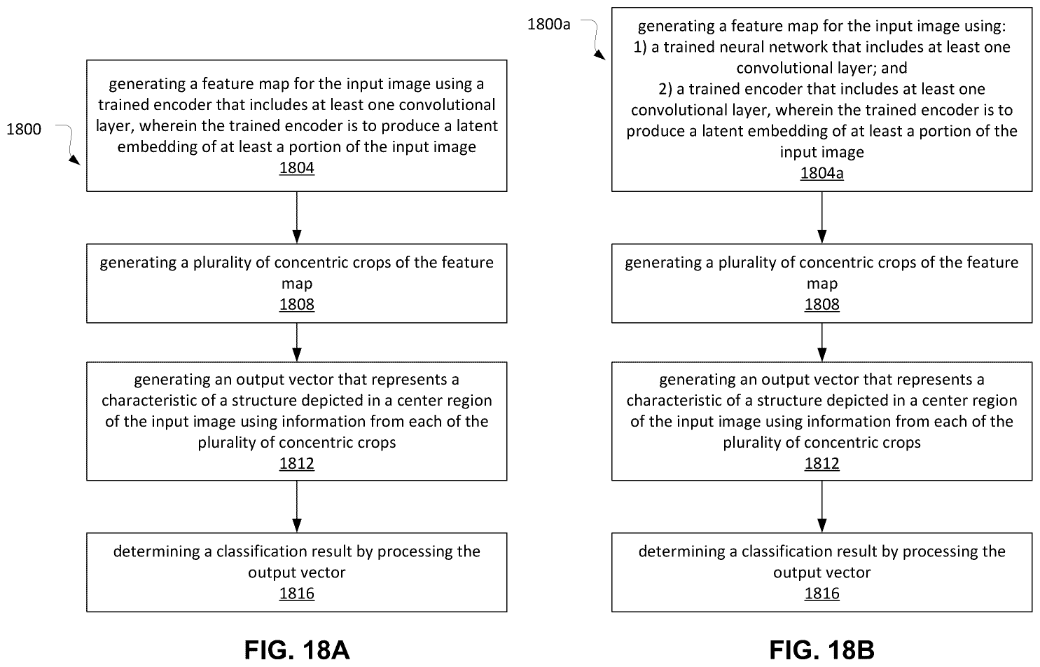

FIGS. 18A-30 show further examples of methods and architecture components that extend examples as described above that may use center emphasis of a feature map (e.g., radius convolution). The ending elements of these methods and components are similar to those described above, but the feature map processed by the ending elements has more features which are generated by additional elements. The additional elements may include, for example, concatenation of feature maps from more than one model (e.g., feature maps from EfficientNet-B2 and from a regional variational autoencoder) and/or a concatenation of or with feature maps from one or more other CNN backends (e.g., a regional autoencoder; a U-Net; one or more other networks pre-trained either on a dataset of images from the ImageNet project or NoisyStudent dataset, which may be further fine-tuned on a specialized dataset (e.g., a dataset of images that depict biological cells)).

FIGS. 18A-24 relate to implementations of techniques as described above that include a trained encoder configured to produce a feature map. Such an encoder (e.g., the encoder of an encoder-decoder or ‘autoencoder’ network, such as, for example, a variational autoencoder) may be trained to extract features that are independent to coloring type, and an optimal strategy for transfer learning with a specialized dataset of training images brought improvement of quality on data from laboratories, scanners and colorings never seen in the training process.

FIG. 18A illustrates a flowchart for an exemplary process 1800 to classify an input image. Process 1800 may be performed using one or more computing systems, models, and networks (e.g., as described herein with respect to FIG. 31). With reference to FIG. 18A, a feature map for the input image is generated at block 1804 using a trained encoder that includes at least one convolutional layer, wherein the trained encoder is to produce a latent embedding of at least a portion of the input image. At block 1808, a plurality of concentric crops of the feature map is generated (e.g., as described above with reference to block 408). For each of the plurality of concentric crops, a center of the feature map may be coincident with a center of the crop. At block 1812, an output vector that represents a characteristic of a structure depicted in a center region of the input image using the plurality of concentric crops is generated (e.g., as described above with reference to block 412). The structure depicted in the center region of the input image may be, for example, a structure to be classified. The structure depicted in the center region of the input image may be, for example, a biological cell. At block 1816, a classification result is determined by processing the output vector (e.g., as described above with reference to block 416). The classification result may predict, for example, that the input image depicts a mitotic figure.

FIG. 18B illustrates a flowchart for an exemplary process 1400a to classify an input image. Process 400 may be performed using one or more computing systems, models, and networks (e.g., as described herein with respect to FIG. 31). With reference to FIG. 18B, a feature map for the input image is generated at block 1804a using a trained neural network that includes at least one convolutional layer and a trained encoder that includes at least one convolutional layer, wherein the trained encoder is to produce a latent embedding of at least a portion of the input image. The trained neural network may be, for example, an implementation of network 420 (e.g., 422) as described herein, and the feature map may be based on an instance of feature map 210 as described herein. Blocks 1808, 1812, and 1816 are as described above with reference to FIG. 18A. Implementations of processes 1800 and 1800a are described in further detail below.

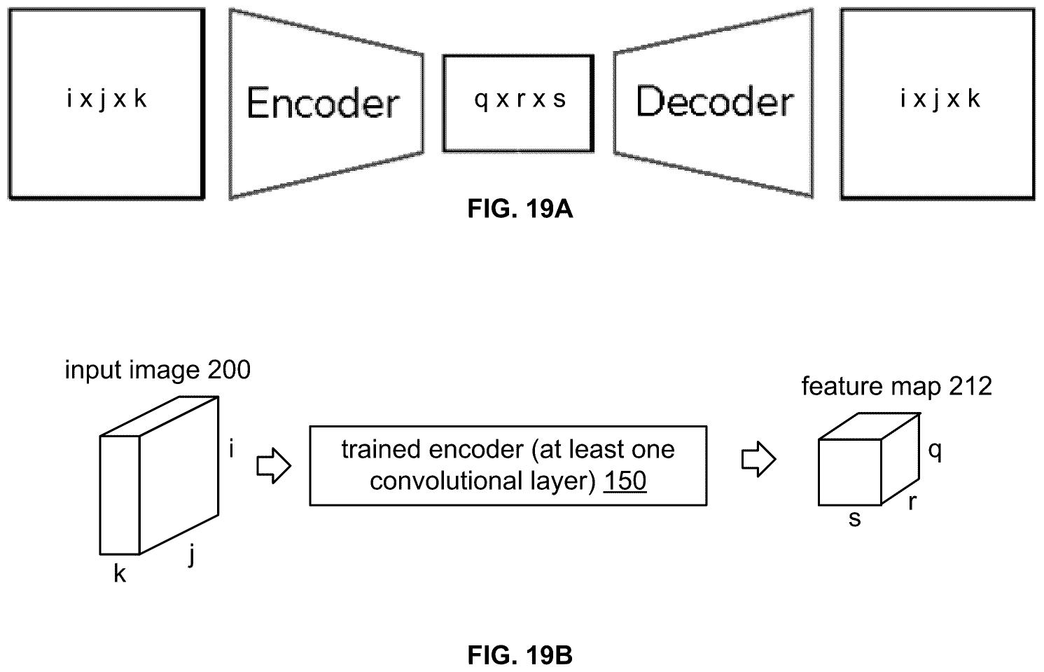

FIG. 19A shows a schematic diagram of an encoder-decoder (or ‘autoencoder’) network that is configured to receive an input image of size (i×j) spatial elements×k channels, to encode the image into a feature map in a latent embedding space of size q×rx s, and to decode the feature map to produce a reconstructed image of size (i×j) spatial elements×k channels. FIG. 19B shows an example of block 1804 in which the feature map 212 is produced by a trained encoder 150 of such an encoder-decoder network.

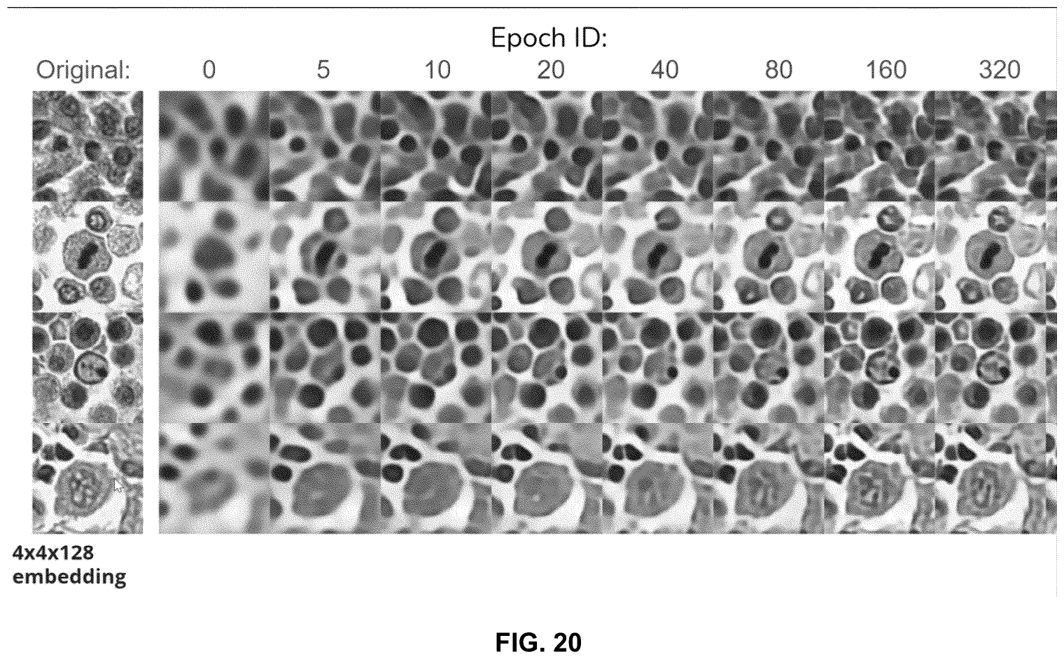

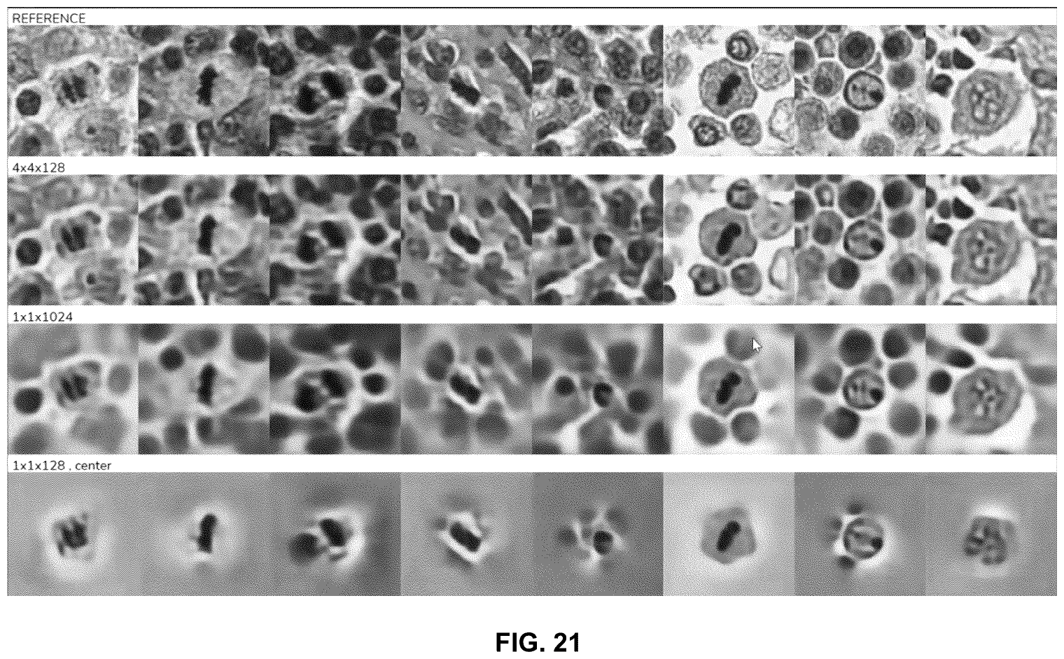

FIG. 20 shows examples of input images and corresponding reconstructed images as produced by an encoder-decoder network characterized by a latent embedding space of size 4×4×128 at various epochs during training. FIG. 21 shows examples of input images (labeled as “REFERENCE”) and corresponding reconstructed images as produced by a encoder-decoder network for latent embedding spaces of different sizes (4×4×128, 1×1×1024, and 1×1×128).

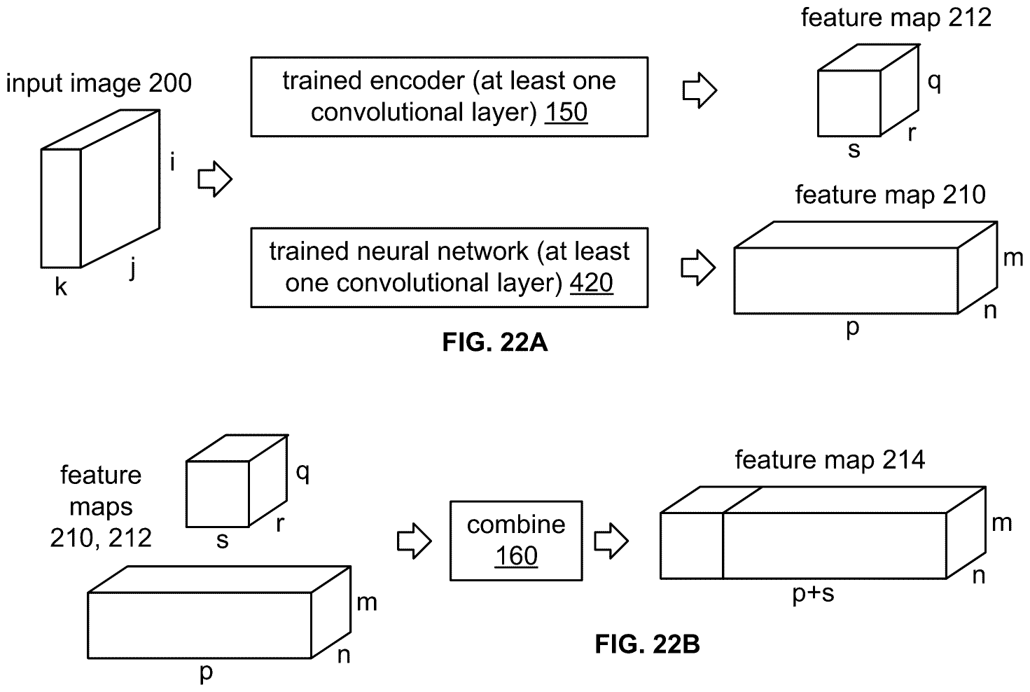

FIGS. 22A and 22B show an example of block 1804a in which a feature map 212 is produced from an input image 200 using a trained encoder 150 and a feature map 210 is produced from the input image 200 using the trained neural network 420 (in FIG. 22A) and a feature map 214 is generated using the feature maps 210, 212 and a combining operation 160 (in FIG. 22B). In this particular example, the size of the feature map 212 is (q×r) spatial elements×s channels, and the size of the feature map 210 is (m×n) spatial elements×p channels. The combining operation 160 may include resizing one or more of the feature maps 210, 212 to a common size along the spatial dimensions and then concatenating the common-size feature maps to generate feature map 214.

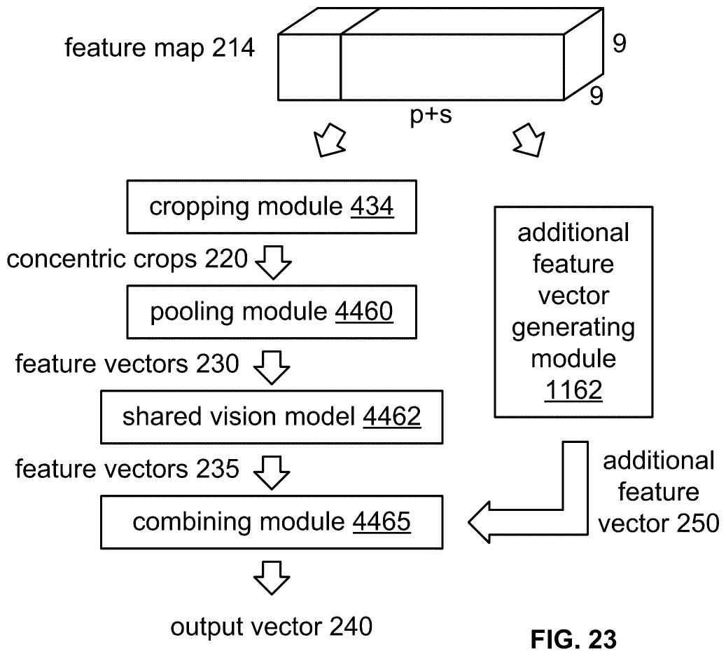

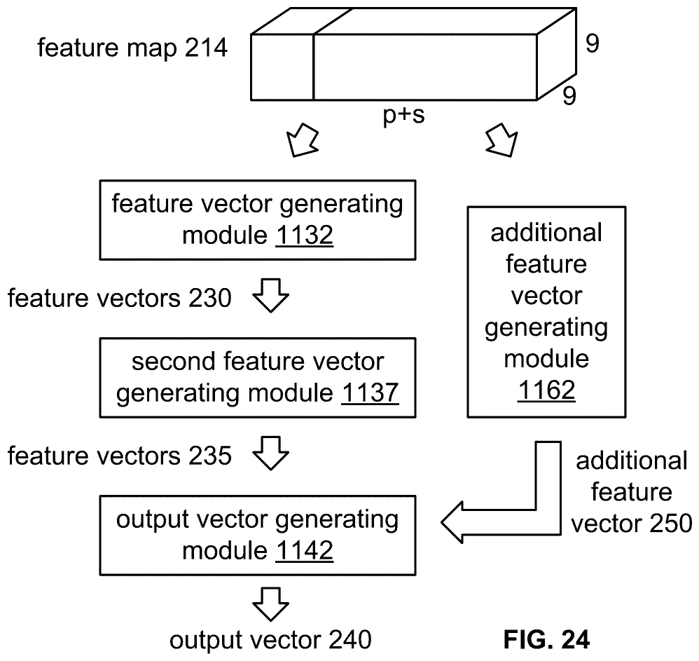

Modules 430, 440, and 450 of architecture component 405 as described herein may be used to perform blocks 1808, 1812, and 1816. FIG. 23 shows a block diagram of such an example in which a feature map 214 of size (9×9) spatial elements×(p+s) channels (e.g., features) is processed using instances of cropping module 434, pooling module 4460, shared vision model 4462, combining module 4465, and additional feature vector generating module 1162 as described herein to produce output vector 240. Likewise, modules 1130, 1135, 1140, and 1150 of architecture component 405 as described herein may be used to perform blocks 1808, 1812, and 1816. FIG. 24 shows a block diagram of such an example in which the feature map 214 of size (9×9)×(p+s) is processed using instances of feature vector generating module 1132, second feature vector generating module 1137, output vector generating module 1142, and additional feature vector generating module 1162 as described herein to produce output vector 240.

### 6. Backend Variations: Multiple Feature Maps (e.g., “Feature Pyramid”)

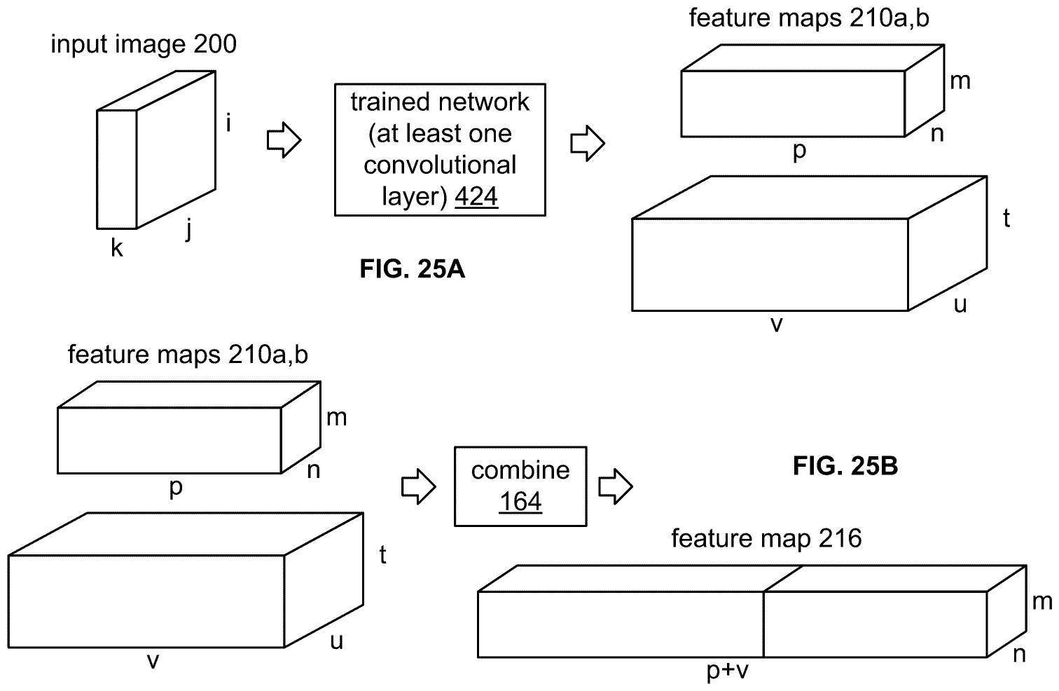

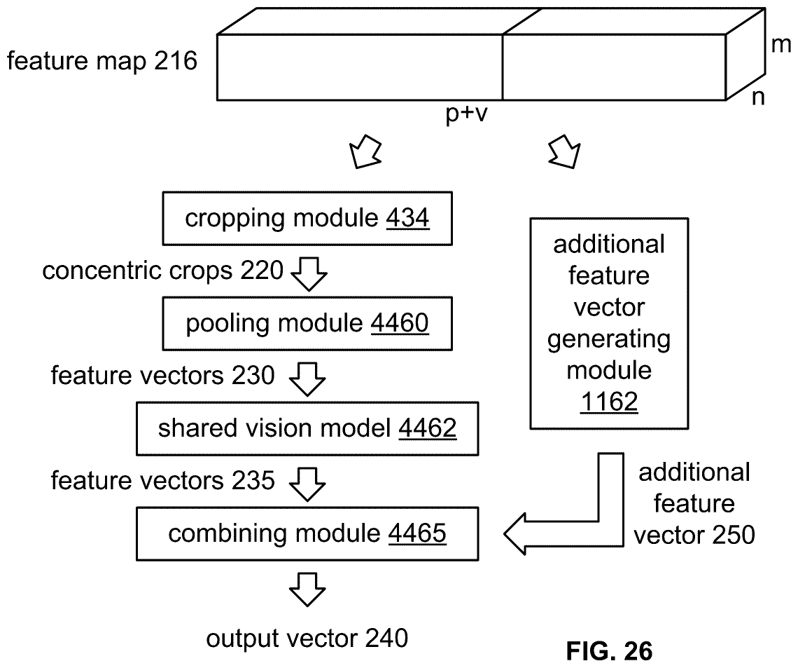

It may be desired to implement an architecture as described herein to combine multiple feature maps. For example, it may be desired to combine feature maps that represent an input image at different scales (e.g., a pyramid of feature maps). FIGS. 25A and 25B show an example of actions in which a plurality of feature maps 210 are produced from an input image 200 by an implementation 424 of a trained neural network 420 (in FIG. 25A) and a feature map 216 is generated using the feature maps 210 and a combining operation 164 (in FIG. 25B). In this particular example, the number of feature maps 210 in the plurality is two, and the sizes of the feature maps 210 arc (m×n) spatial elements×p channels and (t×u) spatial elements×v channels. The combining operation 164 may include resizing (e.g., rescaling) one or more of the feature maps 210 to a common size (e.g., m×n in the example of FIG. 25B) along the spatial dimensions and then concatenating the common-size feature maps to generate feature map 216. FIG. 26 shows a block diagram of an example in which a feature map 216 of size (9×9) spatial elements×(p+v) channels (e.g., features) is processed using instances of cropping module 434, pooling module 4460, shared vision model 4462, combining module 4465, and additional feature vector generating module 1162 as described herein to produce output vector 240.

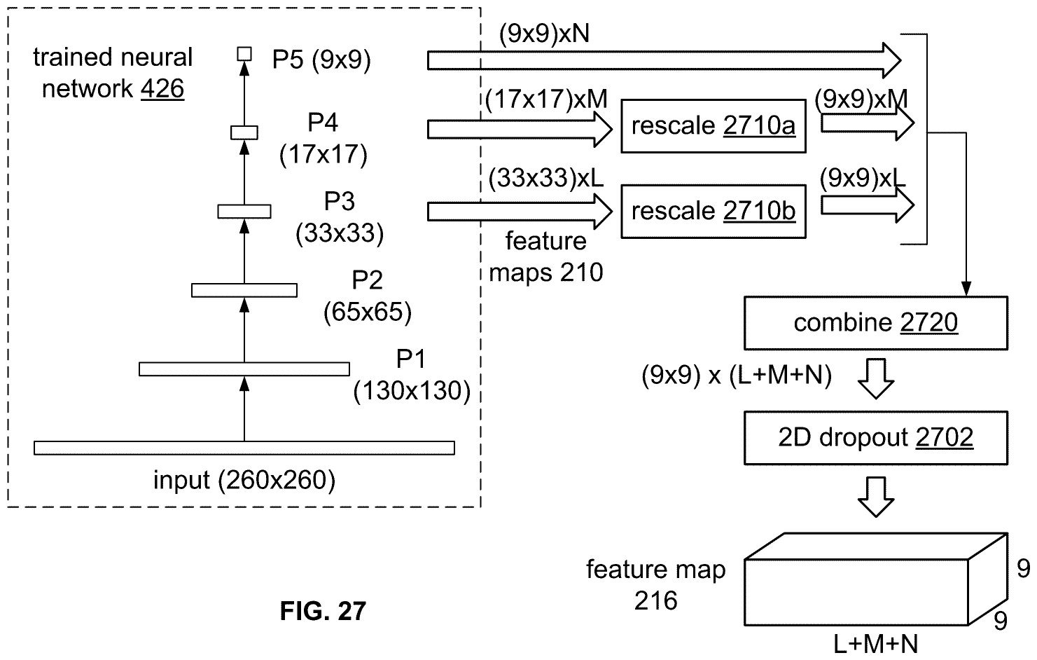

Each of the plurality of feature maps 210 may be an output of a different corresponding layer of a backbone. FIG. 27 shows a block diagram of a particular example in which each of the plurality of feature maps 216 is obtained as the output of a corresponding final layer of an EfficientNet-B2 implementation 426 of the trained neural network 420. In this example, two of the feature maps 210 are rescaled to the common size of (9×9) spatial elements, the common-sized feature maps are combined (concatenated), and a 2D dropout operation is applied to the concatenated map to produce feature map 216. FIG. 28 shows a block diagram of an example in which a feature map 216 of size (9×9) spatial elements×(L+M+N) channels (e.g., features) is processed using instances of cropping module 434, pooling module 4460, shared vision model 4462, combining module 4465, and additional feature vector generating module 1162 as described herein to produce output vector 240.

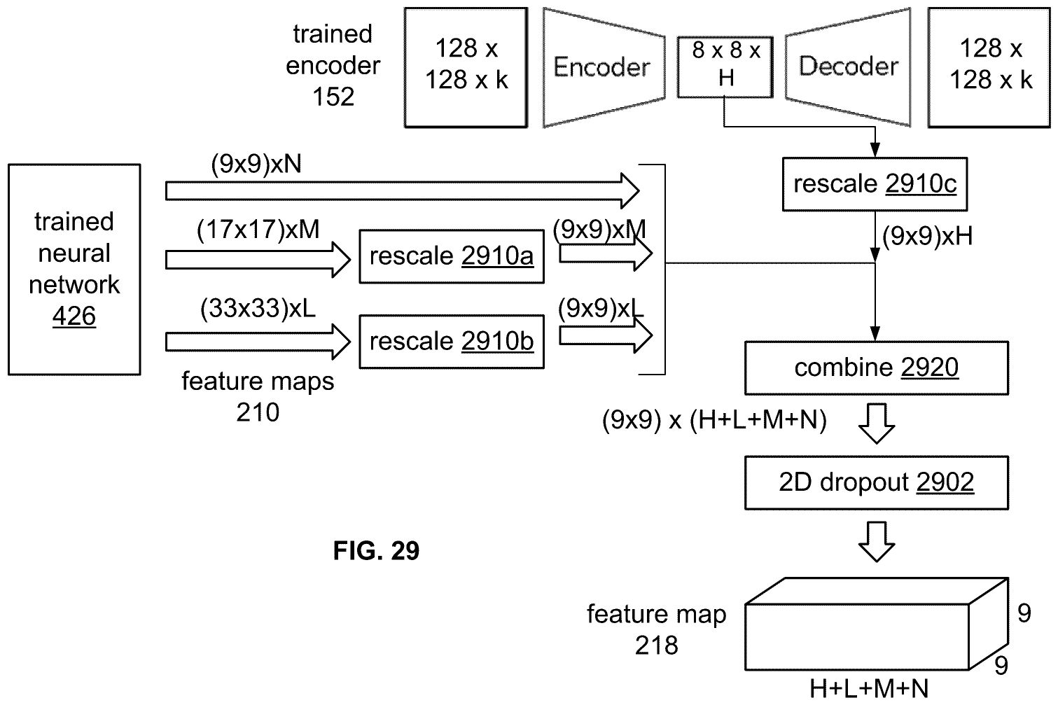

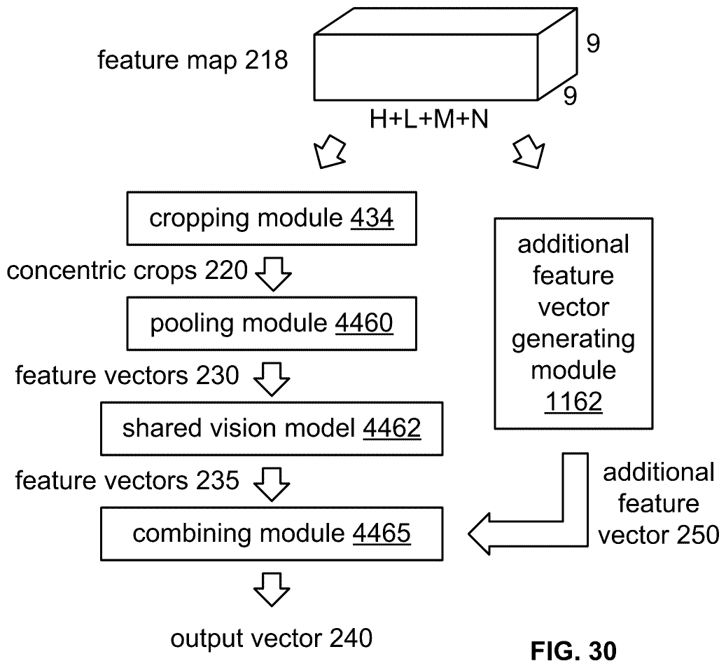

FIGS. 29 and 30 show examples that combine feature maps from a pyramid as described above with a feature map from a trained encoder as also described above. FIG. 29 shows a block diagram of a particular example in which a feature map of dimensions (8×8)×H as generated using a trained encoder 152 is rescaled and combined (concatenated) with a plurality of common-sized feature maps as shown in FIG. 27, and a 2D dropout operation is applied to the concatenated map to produce feature map 218. FIG. 30 shows a block diagram of an example in which a feature map 218 of size (9×9) spatial elements×(H+L+M+N) channels (e.g., features) is processed using instances of cropping module 434, pooling module 4460, shared vision model 4462, combining module 4465, and additional feature vector generating module 1162 as described herein to produce output vector 240.

FIG. 31 shows an example of a computing system 3100 that may be configured to perform a method as described herein.

### 7. Experiments

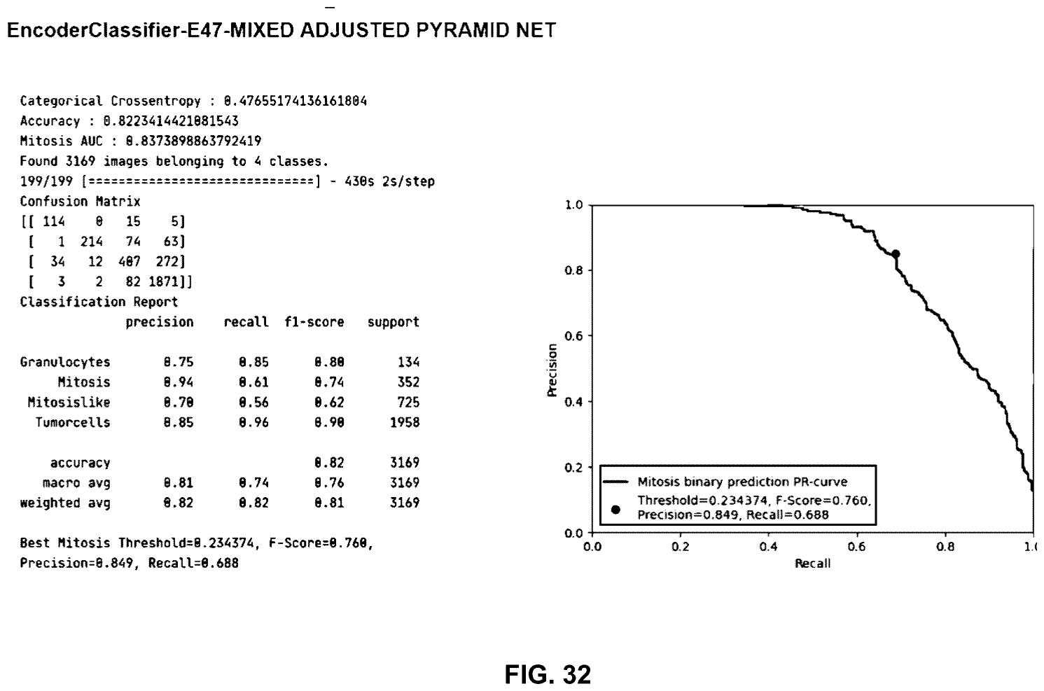

Four experiments as described below were performed, and the results were evaluated using the parameters VACC (Validation Accuracy) and VMAUC (Validation Mitosis Arca Under the Curve) for the same validation set. The parameter VACC was calculated by measuring accuracy over all four classes and averaging the results. In this case, accuracy is measured with reference to top-1 classification (e.g., for each prediction, only the class with the highest classification score is “yes,” and the three others are all “no”). The parameter VMAUC was calculated as the area under the precision-recall (PR) curve. The PR curve is a plot of the precision (on the Y axis) and the recall (on the X axis) for a single classifier (in this case, the mitosis class only) at various binary thresholds. Each point on the curve corresponds to a different binary threshold and indicates the resulting precision and recall when that threshold is used. If the score for the mitosis class is equal to or above the threshold, the answer is “yes,” and if the score is below the threshold, the answer is “no.” A higher value of VMAUC (e.g., a larger area under the PR curve) indicates that the overall model performs better over many different binary thresholds, so that it is possible to choose from among these thresholds. Out of these checkpoints, one with the best achieved VMAUC, and one with the best VACC on four classes (two different criteria of optimization are achieved at different moments of training for the same validation set), are presented in Table 1 below. FIG. 32 shows an example of a PR curve for a model as described herein with reference to FIGS. 29 and 30.

Experiment 1: A training was performed with “flat ending” (global average pooling and one fully connected layer) applied on the last layer of EfficientNet-B2. Checkpoint with best Area Under Precision-Recall Curve for Mitosis class: VACC=0.69833, VMAUC=0.74141; Checkpoint with best validation accuracy (for all 4 classes): VACC=0.72168, VMAUC=0.72249.

Experiment 2: A training with exactly the same parametrization of image augmentations and the same dataset was performed, but with a “light radius convolution” ending (this name indicates one of the implementations of a “radius convolution” model ending as described herein with reference to, e.g., FIGS. 12 and 13): Checkpoint with best Area Under Precision-Recall Curve for Mitosis class: VACC=0.70843, VMAUC=0.74549; Checkpoint with best validation accuracy (for all 4 classes): VACC=0.73178, VMAUC=0.73948. In each optimization metric, this improved architecture (with a “radius convolution” ending) was able to achieve a higher (better) score on the same validation set, and to keep both metrics better than the architecture with “flat ending.”

Experiment 3: With the following improvements, it was possible to achieve better model performance using the same architecture (with an “Efficient Net-B2” backend and a “radius convolution” ending): Checkpoint with best Area Under Precision-Recall Curve for Mitosis class: VACC=0.81161, VMAUC=0.83776; Checkpoint with best validation accuracy (for all 4 classes): VACC=0.82203, VMAUC=0.83076. The improvements include:

Improvement of the training technique (series of trainings with selective freezing/unfreezing of some of neural network layers in specific order, manipulation of learning rate in consecutive training continuation runs). The best working strategy was to choose the set of weights of the model with the best accuracy achieved so far and perform the following actions:
1) first, train just the model ending with the rest of weights frozen, using ADAM gradient descent with high starting learning rate;
2) second, unfreeze the chosen number of last layers of the backend core part of the model and continue training from the best checkpoint, with ADAM, with at least ten times smaller starting learning rate;
3) third, freeze again the entire backend and train just the ending of the neural network (similar to the first step, but with even lower initial learning rate).

Improvements of data augmentation (in-house augmentations library mixed with built-in augmentations from Keras and FastAI); these augmentations, and manipulation of their amplitudes and probabilities of occurrence, had a substantial impact on improvements of the results, making the model more robust to scanner, tissue and/or stain variations. Extending the training set with data that was scanned by the same scanner(s) as the validation set brought further improvements of robustness on the validation data.

This strategy also included transfer learning from the best model trained on a first dataset (which is acquired from slides of tissue samples by at least one different scanner from the validation dataset), further training only on a second dataset (which is acquired from slides of tissue samples by the same scanner(s) as the validation dataset) until the model stops improving, and then tuning it once again on the mixed training set. The slides used to obtain the second dataset may be from a different laboratory, a different organism (e.g., dog tissue vs. human tissue), a different kind of tissue (for example, skin tissue versus a variety of different breast tissues), and/or a different kind of tumor (for example, lymphoma versus breast cancer) than the slides used to obtain the first dataset. Additionally or alternatively, the slides used to obtain the second dataset may be colored with chemical coloring substances and/or in different ratios than the slides used to obtain the first dataset. The scanner(s) used to obtain the first dataset may have different color, brightness, and/or contrast characteristics than the scanner(s) used to obtain the second dataset. Several strategies of mixing different proportions of the first dataset and the second dataset were tried, and the best one was chosen.

Experiment 4: In further experiments, the strategy stayed the same, but additional feature extraction backend models were added, to provide a mixture of feature maps with pre-trained knowledge. The strategy of “pyramid of features” was used (chosen earlier layers of backend model were scaled down to match the size of the last layer, and they were concatenated to create one feature map that has more features corresponding to each local region in the input image, and these features represent various levels of abstraction). In this strategy, during the model fine-tuning, many more end layers of the model backbone were unfrozen. In some cases, the entire model backbone was unfrozen for the fine-tuning, and in other cases, only the last pyramid level and the model ending were unfrozen. In one particular example, an EfficientNet-B0 model backbone was used, and the last twenty layers were unfrozen for the fine-tuning (e.g., the eighteen layers of the last pyramid level of the backbone, and the two layers of the model ending on top of the last pyramid level). In another particular example, an EfficientNet-B2 model backbone was used, and the last thirty-five layers were unfrozen for the fine-tuning (e.g., the thirty-three layers of the last pyramid level of the backbone, and the two layers of the model ending on top of the last pyramid level). (It is noted that the ending of a model which applies radius convolution as described herein may have more than two layers.) In other such examples, the entire model backbone was unfrozen for the fine-tuning. Additionally, the feature map from the bottleneck layer of one of the regional variational autoencoders was added to extend the feature map even further. The autoencoders were trained on various cells from H&E tissue images, with the same assumption that each cell is in the center of the image crop.

Such experiments brought slight further improvements: Best achieved Area Under Precision-Recall Curve for Mitosis class: VMAUC=0.83966; Best achieved validation accuracy (for all 4 classes): VACC=0.82550. In this approach, the ending of the “radius convolution” model was changed only to accommodate an increase in the number of input features per region of the feature map.

TABLE 1

| | |
|---|---|
| For Mitosis class | For all four classes |

| | VACC | VMAUC | VACC | VMAUC |
|---|---|---|---|---|
| Experiment 1 | 0.69833 | 0.74141 | 0.72168 | 0.72249 |
| Experiment 2 | 0.70843 | 0.74549 | 0.73178 | 0.73948 |
| Experiment 3 | 0.81161 | 0.83776 | 0.82203 | 0.83076 |
| Experiment 4 | | 0.83966 | 0.82550 | |

### 8. Exemplary System For Center Emphasis

FIG. 31 is a block diagram of an example computing environment with an example computing device suitable for use in some example implementations, for example, performing the methods 400, 1100, 1700, 1710, 1800, and/or 1800a. The computing device 3105 in the computing environment 3100 may include one or more processing units, cores, or processors 3110, memory 3115 (e.g., RAM, ROM, and/or the like), internal storage 3120 (e.g., magnetic, optical, solid state storage, and/or organic), and/or I/O interface 3125, any of which may be coupled on a communication mechanism or a bus 3130 for communicating information or embedded in the computing device 3105.

The computing device 3105 may be communicatively coupled to an input/user interface 3135 and an output device/interface 3140. Either one or both of the input/user interface 3135 and the output device/interface 3140 may be a wired or wireless interface and may be detachable. The input/user interface 3135 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). The output device/interface 3140 may include a display, television, monitor, printer, speaker, braille, or the like. In some example implementations, the input/user interface 3135 and the output device/interface 3140 may be embedded with or physically coupled to the computing device 3105. In other example implementations, other computing devices may function as or provide the functions of the input/user interface 3135 and the output device/interface 3140 for the computing device 3105.

The computing device 3105 may be communicatively coupled (e.g., via the I/O interface 3125) to an external storage device 3145 and a network 3150 for communicating with any number of networked components, devices, and systems, including one or more computing devices of the same or different configuration. The computing device 3105 or any connected computing device may be functioning as, providing services of, or referred to as a server, client, thin server, general machine, special-purpose machine, or another label.

The I/O interface 3125 may include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in the computing environment 3100. The network 3150 may be any network or combination of networks (e.g., the Internet, local area network, wide area network, a telephonic network, a cellular network, satellite network, and the like).

The computing device 3105 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

The computing device 3105 can be used to implement techniques, methods, applications, processes, or computer-executable instructions in some example computing environments. Computer-executable instructions can be retrieved from transitory media, and stored on and retrieved from non-transitory media. The executable instructions may originate from one or more of any programming, scripting, and machine languages (e.g., C, C++, C#, Java, Visual Basic, Python, Perl, JavaScript, and others).

The processor(s) 3110 may execute under any operating system (OS) (not shown), in a native or virtual environment. One or more applications may be deployed that include a logic unit 3160, an application programming interface (API) unit 3165, an input unit 3170, an output unit 3175, a boundary mapping unit 3180, a control point determination unit 3185, a transformation computation and application unit 3190, and an inter-unit communication mechanism 3195 for the different units to communicate with each other, with the OS, and with other applications (not shown). For example, the trained neural network 420, the cropping module 430, the output vector generating module 440, and the classifying module 450 may implement one or more processes described and/or shown in FIGS. 4A, 11A, 17A, 17B, 18A, and/or 18B. The described units and elements can be varied in design, function, configuration, or implementation and are not limited to the descriptions provided.

In some example implementations, when information or an execution instruction is received by the API unit 3165, it may be communicated to one or more other units (e.g., the logic unit 3160, the input unit 3170, the output unit 3175, the trained neural network 420, the cropping module 430, the output vector generating module 440, and/or the classifying module 450). For example, after the input unit 3170 has detected user input, it may use the API unit 3165 to communicate the user input to an implementation 112 of detector 100 to generate an input image (e.g., from a WSI, or a tile of a WSI). The trained neural network 420 may, via the API unit 3165, interact with the detector 112 to receive the input image and generate a feature map. Using the API unit 3165, the cropping module 430 may interact with the trained neural network 420 to receive the feature map and generate a plurality of concentric crops. Using the API unit 3165, the output vector generating module 440 may interact with the cropping module 430 to receive the concentric crops and generate an output vector that represents a characteristic of a structure depicted in a center region of the input image using information from each of the plurality of concentric crops. Using the API unit 3165, the classifying module 450 may interact with the output vector generating module 440 to receive the output vector and determine a classification result by processing the output vector. Further example implementations of applications that may be deployed may include a second feature vector generating module 1135 as described herein (e.g., with reference to FIG. 11B).

In some instances, the logic unit 3160 may be configured to control the information flow among the units and direct the services provided by the API unit 3165, the input unit 3170, the output unit 3175, the trained neural network 420, the cropping module 430, the output vector generating module 440, and the classifying module 450 in some example implementations described above. For example, the flow of one or more processes or implementations may be controlled by the logic unit 3160 alone or in conjunction with the API unit 3165.

### 9. Additional Considerations

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification, and variation of the concepts herein disclosed may be resorted to by those skilled in the art, and that such modifications and variations are considered to be within the scope of this invention as defined by the appended claims.

The description provides preferred exemplary embodiments only, and is not intended to limit the scope, applicability or configuration of the disclosure. Rather, the description of the preferred exemplary embodiments will provide those skilled in the art with an enabling description for implementing various embodiments. It is understood that various changes may be made in the function and arrangement of elements without departing from the spirit and scope as set forth in the appended claims.

Specific details are given in the following description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

1. A computer-implemented method for classifying an input image, the method comprising:
generating a feature map for the input image using a trained neural network that includes at least one convolutional layer;
generating a plurality of concentric crops of the feature map;
generating an output vector that represents a characteristic of a structure depicted in a center region of the input image using information from each of the plurality of concentric crops; and
determining a classification result by processing the output vector.

2. The computer-implemented method of claim 1, wherein the structure depicted in the center region of the input image is a structure to be classified.

3. The computer-implemented method of claim 1, wherein the structure depicted in the center region of the input image is a biological cell.

4. The computer-implemented method of claim 1, wherein, for each of the plurality of concentric crops, a center of the feature map is coincident with a center of the crop.

5. The computer-implemented method of claim 1, wherein the classification result predicts that the input image depicts a mitotic figure.

6. The computer-implemented method of claim 1, further comprising generating a latent embedding of at least a portion of the input image using a trained encoder that includes at least one convolutional layer, wherein generating the feature map also uses the latent embedding.

7. The computer-implemented method of claim 1, further comprising generating each of a plurality of feature maps using a respective one of a plurality of final layers of the trained neural network, wherein generating the feature map uses a concatenation of the plurality of feature maps.

8. The computer-implemented method claim 1, wherein generating the output vector using information from each of the plurality of concentric crops includes:
for each of the plurality of concentric crops, generating a corresponding one of a plurality of feature vectors using at least one pooling operation; and
generating the output vector using information from each of the plurality of feature vectors.

9. The computer-implemented method of claim 8, wherein generating the output vector using information from each of the plurality of feature vectors comprises generating the output vector using a weighted sum of the plurality of feature vectors.

10. The computer-implemented method of claim 8, further comprising ordering the plurality of feature vectors by radial size of the corresponding concentric crop, and
wherein generating the output vector includes convolving a trained filter separately over adjacent pairs of the ordered plurality of feature vectors.

11. The computer-implemented method of claim 8, wherein the plurality of feature vectors is ordered by radial size of the corresponding concentric crop, and
wherein generating the output vector includes:
convolving a trained filter over a first adjacent pair of the ordered plurality of feature vectors to produce a first combined feature vector; and
convolving the trained filter over a second adjacent pair of the ordered plurality of feature vectors to produce a second combined feature vector, and
wherein generating the output vector using the plurality of feature vectors comprises generating the output vector using the first combined feature vector and the second combined feature vector.

12. The computer-implemented method of claim 8, wherein generating the output vector using the plurality of feature vectors comprises:
generating a second plurality of feature vectors using a trained model, comprising applying the trained model separately to each of the plurality of feature vectors; and
generating the output vector using information from each of the second plurality of feature vectors.

13. The computer-implemented method of claim 12, wherein generating the output vector using information from each of the second plurality of feature vectors comprises generating the output vector using a weighted sum of the second plurality of feature vectors.

14. The computer-implemented method of claim 1, further comprising selecting the input image as a patch of a larger image using a second trained neural network, wherein a center region of the input image depicts a biological cell.

15. The computer-implemented method of claim 1, wherein processing the output vector comprises applying a sigmoid function to the output vector.

16. A computer-implemented method for classifying an input image, the method comprising:
generating a feature map for the input image;
generating a plurality of feature vectors using the feature map;
generating a second plurality of feature vectors using a trained model, comprising applying the trained model separately to each of the plurality of feature vectors;
generating an output vector that represents a characteristic of a structure depicted in the input image using information from each of the second plurality of feature vectors; and
determining a classification result by processing the output vector.

17. The computer-implemented method of claim 16, wherein generating the plurality of feature vectors using the feature map includes using at least one pooling operation.

18. The computer-implemented method of claim 16, wherein the structure is depicted in a center portion of the input image.

19. The computer-implemented method of claim 16, wherein generating the output vector using the second plurality of feature vectors comprises generating the output vector using a weighted sum of the second plurality of feature vectors.

20. A computer-implemented method for training a classification model that includes a first neural network and a second neural network, the method comprising:
generating a plurality of feature maps using the first neural network and information from images of a first dataset; and
training the second neural network using information from each of the plurality of feature maps,
wherein each image of the first dataset depicts at least one biological cell, and
wherein the first neural network is pre-trained on a plurality of images of a second dataset that includes images which do not depict biological cells.

21. The computer-implemented method of claim 20, wherein the plurality of images of the second dataset includes images that depict non-biological structures.

22. The computer-implemented method of 20, wherein, for each image of the first dataset, a center region of the image depicts at least one biological cell.

23. A computer-implemented method for classifying an input image, the method comprising:
generating a feature map for the input image using a first trained neural network of a classification model;
generating an output vector that represents a characteristic of a structure depicted in a center portion of the input image using a second trained neural network of the classification model and information from the feature map; and
determining a classification result by processing the output vector,
wherein the input image depicts at least one biological cell, and
wherein the first trained neural network is pre-trained on a first plurality of images that includes images which do not depict biological cells, and
wherein the second trained neural network is trained by providing the classification model with a second plurality of images that depict biological cells.

24. The computer-implemented method of claim 23, wherein the first plurality of images includes images that depict non-biological structures.

25. The computer-implemented method of claim 23, wherein, for each image of the second plurality of images, a center region of the image depicts at least one biological cell.
